(19) United States
(12) Patent Application Publication
(10) Pub. No.: US 2026/0353115 A1
(43) Pub. Date: Nov. 5, 2026

(54) METHODS AND APPARATUSES FOR BEAM FAILURE RECOVERY (BFR)

(71) Applicant: InterDigital Patent Holdings, Inc., Wilmington, DE (US)

(72) Inventors: Jonghyun PARK, Syosset, NY (US); Moon IL LEE, Melville, NY (US); Nazli KHAN BEIGI, Longueuil (CA); Jongwoo HONG, New York, NY (US); Virgile GARCIA, Antibes (FR)

(73) Assignee: InterDigital Patent Holdings, Inc., Wilmington, DE (US)

(21) Appl. No.: 19/198,967

(22) Filed: May 5, 2025

(51) Int. Cl. H04W 24/04; H04B 17/318; H04L 5/00; H04W 24/08; H04W 74/0833

(52) U.S. Cl. CPC H04W 24/04; H04B 17/328; H04L 5/0048; H04W 24/08; H04W 74/0833

(57) ABSTRACT

The present disclosure pertains to wireless communication systems, focusing on methods and a WTRU for recovering downlink (DL) beams during beam failure. A WTRU receives configuration information, including counter parameters, uplink (UL) channel types, beam failure detection (BFD) reference signals (RSs) associated with a first threshold, and candidate DL RSs associated with a second threshold. The WTRU measures DL beam quality, increments a BFD counter when metrics fall below a threshold, performs a first beam failure recovery (BFR) operation including selecting a first candidate DL RS, sends one or more recovery requests via UL channels, and monitors for a response. The WTRU performs a second BFR operation including selecting a second candidate DL RSs when a response is not received within a first maximum counter parameter, and resets the BFD counter and applies the second candidate DL RSs upon successful reception of a response to the second BFR operation.

### BACKGROUND

In conventional wireless systems, DL and UL transmissions are typically coupled, meaning that the same transmission and reception point (TRP) handles both transmission and reception. However, emerging network architectures are increasingly adopting decoupled DL/UL TRPs, where separate TRPs are used for DL transmission and UL reception. This decoupling offers several advantages, including improved interference management, enhanced uplink coverage, and reduced deployment costs. For example, a DL TRP may be optimized for high-power directional transmissions, while a UL TRP may be optimized for sensitive reception, particularly for cell-edge user equipment (UE)/wireless transmit/receive unit (WTRU). These decoupled configurations are often connected via ideal backhaul links, enabling flexible and efficient network deployments.

Another advancement in wireless communication is the adoption of SBFD operations, where subbands within the same frequency band are allocated separately for DL and UL transmissions. SBFD enables simultaneous DL and UL operations within a single time slot, improving spectral efficiency and reducing latency. However, SBFD systems face unique challenges, such as cross-link interference (CLI) and self-interference (SI), which can degrade communication reliability.

Beam failure is a critical issue in directional communication systems, particularly in dynamic environments where beam misalignment, blockage, or degradation can occur due to user mobility, environmental changes, or interference. Existing BFR methods are often designed for coupled DL/UL TRPs and do not adequately address the complexities introduced by decoupled TRPs and SBFD operations. For instance, in decoupled TRP scenarios, a beam failure in the DL path may not necessarily correspond to a failure in the UL path, leading to ambiguities in failure detection and recovery. Similarly, SBFD systems require frequency-specific beam management to account for varying interference and propagation conditions across subbands.

Conventional BFR methods typically rely on a single-step recovery process, where the WTRU transmits a beam failure recovery request (BFRR) to the network upon detecting a beam failure. However, these methods may be insufficient in decoupled TRP and SBFD scenarios, where more sophisticated recovery mechanisms are needed to address the spatial and frequency-domain complexities. Additionally, existing methods often lack the ability to independently manage UL and DL beam failures, further limiting their effectiveness in advanced network deployments.

Therefore, there is a need for improved BFR methods that can effectively operate in decoupled DL/UL TRP and SBFD scenarios. Such solutions may enable multi-step recovery processes, independent UL and DL beam management, and frequency-specific recovery mechanisms to ensure robust and reliable communication in next-generation wireless networks.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method for recovering a downlink beam is performed by a wireless transmit/receive unit. The method includes receiving configuration information that comprises includes a first maximum counter parameter and information associated with a first uplink (UL) channel type, a second maximum counter parameter and information associated with a second UL channel type, a set of beam failure detection (BFD) reference signals (RSs) associated with a first threshold, and a set of candidate downlink (DL) RSs associated with a second threshold. The Method may also include measuring quality metrics of a received DL beam based on the BFD RSs, and incrementing a BFD counter each time a respective measured quality metric is below the first threshold. The Method may furthermore include performing a first beam failure recovery (BFR) operation when the BFD counter reaches the first maximum counter parameter, where the first BFR operation includes selecting a first candidate DL RS. The Method may in addition include monitoring for a network response associated with the first BFR operation. The Method may moreover include if the network response associated with the first BFR operation is not received prior to the BFD counter reaching the first maximum counter parameter, performing a second BFR operation, where the second BFR operation includes selecting a second candidate DL RS. The Method may also include resetting the BFD counter and applying the second candidate DL RS for subsequent DL reception upon successful reception of a response to the second BFR operation. Other embodiments of this aspect include corresponding computer systems, apparatus, and computer programs recorded on one or more computer storage devices, each configured to perform the actions of the methods.

Implementations may include one or more of the following features. The Method where the configuration information further includes a plurality of DL transmission configuration indicator (DL-TCI) states associated with a DL transmission point (DL-TRP), a plurality of UL-TCI states associated with an UL transmission point (UL-TRP), and one or more associations linking one or more DL resources or parameters of the DL-TRP to one or more UL resources or parameters of the UL-TRP. The method where the first BFR operation may include: selecting the first candidate DL RS from among the set of candidate DL RSs based on a quality metric of the first candidate DL RS meeting or exceeding the second threshold; and transmitting, using the first UL channel type and a first UL spatial-domain filter, a first beam failure recovery request message having an identifier of the first candidate DL RS, and where the network response being monitored is associated with the selected first candidate DL RS using a spatial-domain filter determined according to the selected first candidate DL RS. The method where the second BFR operation may include: selecting the second candidate DL RS from the set of candidate DL RSs based on a quality metric of the second candidate DL RS meeting or exceeding the second threshold, determining a corresponding UL beam according to the one or more associations linking one or more DL resources or parameters of the DL-TRP to one or more UL resources or parameters of the UL-TRP, identifying a random access occasion (RO) associated with the second candidate DL RS, and transmitting, using the second UL channel type and a second uplink spatial-domain filter, a second beam failure recovery request message toward the UL-TRP. The method where the first UL spatial-domain filter is determined based on one of the UL-TCI states, and where the second uplink spatial-domain filter is determined based on the corresponding UL beam. The method may include determining a first UL-TCI state from the plurality of UL-TCI states associated with the UL-TRP for performing UL transmissions. The method where the first UL channel type may include one of a physical uplink shared channel (PUSCH), a physical uplink control channel (PUCCH), or a media access control (MAC) control element (MAC-CE), and where the second UL channel type may include a physical random access channel (PRACH). The method the one or more associations linking one or more DL resources or parameters of the DL-TRP to one or more UL resources or parameters of the UL-TRP include an association linking of any one of: a DL SSB, CSI-RS, or DL TCI state associated with the DL-TRP with any one of: an UL SSB, SRS, or UL-TCI state associated with the UL-TRP. The method where identifying the RO associated with the second candidate DL RS is based on a preconfigured SSB-to-RO mapping rule. Method where measuring quality metrics of the received DL beam may include measuring a reference signal received power (RSRP), and where the first threshold is based on a predetermined RSRP threshold. Implementations of the described techniques may include hardware, a method or process, or a computer tangible medium.

In another general aspect, A wireless transmit/receive unit (WTRU may include processor circuitry and a transceiver coupled to the processor circuitry and configured to receive configuration information that includes a first maximum counter parameter and information associated with a first uplink (UL) channel type, a second maximum counter parameter and information associated with a second UL channel type, a set of beam failure detection (BFD) reference signals (RSs) associated with a first threshold, and a set of candidate downlink (DL) RSs associated with a second threshold. The WTRU may furthermore include the processor circuitry configured to: measure quality metrics of a received DL beam based on the BFD RSs, and incrementing a BFD counter each time a respective measured quality metric is below the first threshold; perform a first beam failure recovery (BFR) operation when the BFD counter reaches the first maximum counter parameter, where the first BFR operation includes selecting a first candidate DL RS; monitor for a network response associated with the first BFR operation, if the network response associated with the first BFR operation is not received prior to the BFD counter reaching the first maximum counter parameter, perform a second BFR operation, where the second BFR operation includes selecting a second candidate DL RS, and reset the BFD counter and applying the second candidate DL RS for subsequent DL reception upon successful reception of a response to the second BFR operation. Other embodiments of this aspect include corresponding computer systems, apparatus, and computer programs recorded on one or more computer storage devices, each configured to perform the actions of the methods.

In another embodiment, the disclosure provides a wireless transmit/receive unit (WTRU) comprising processor circuitry and a transceiver. The WTRU is configured to receive configuration information that includes maximum counter parameters, associated information for first and second uplink channel types, and sets of beam failure detection and candidate downlink reference signals corresponding to first and second thresholds, respectively. The processor circuitry measures quality metrics of a received downlink beam to increment a beam failure detection counter whenever the measured metric falls below the first threshold, and then performs a beam failure recovery operation by selecting a candidate downlink reference signal when the counter reaches the maximum value. The transceiver is directed to transmit a beam failure recovery request message using the first uplink channel type and a corresponding spatial-domain filter, with the network response being monitored based on parameters determined from the selected candidate. If no timely network response is detected, the processor circuitry selects an alternative candidate downlink reference signal, determines an associated uplink beam via established associations between downlink and uplink resources, identifies a random access occasion (RO) pursuant to a preconfigured mapping rule, and instructs the transceiver to transmit a second beam failure recovery request message using the second uplink channel type and its corresponding spatial-domain filter. In addition, the WTRU may utilize multiple transmission configuration indicator states associated with respective downlink and uplink transmission points, where the first uplink channel type may include options such as physical uplink shared channel, physical uplink control channel, or a MAC CE, and the second uplink channel type comprises a physical random access channel.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of an SBFD configuration in TDD framework;

FIG. 3 illustrates examples of Cross Link Interference (CLI) including inter-gNB and inter-UE CLI;

FIG. 4A is a high level system diagram illustrating a conventional multi-TRP operation with a WTRU connected to multiple TRPs;

FIG. 4B is a high level system diagram depicting an example of asymmetric DL/UL TRPs connected via a backhaul;

FIG. 5 illustrates an example of a DCI field (e.g., TCI field) of a DCI for unified TCI-state indications;

FIG. 6 illustrates an example of TCI beam control access across FD and non-FD symbols;

FIG. 7 illustrates an example of associations between a first SSB and one or more second SSBs;

FIG. 8 illustrates an example of SSB-RO mapping with ascending order of SSB indexes in ROs;

FIG. 9 illustrates an example of associations between a first SSB and one or more second SSBs in an SBFD system;

FIG. 10 illustrates an example of a hybrid BFR method based on multi-step BFR requests; and

FIG. 11 is a flow diagram of an example BFR hybrid beam failure recovery (BFR) process based on multi-step BFR operations.

### DETAILED DESCRIPTION

The following acronyms may be referred to in the description that follows:
CG Configured grant
DG Dynamic grant
MAC CE MAC control element
ACK Acknowledgement
BLER Block Error Rate
BWP Bandwidth Part
C-JT Coherent Joint Transmission
CP Cyclic Prefix
CP-OFDM Conventional OFDM (relying on cyclic prefix)
CQI Channel Quality Indicator
CRC Cyclic Redundancy Check
CSI Channel State Information
DAI Downlink Assignment Index
DCI Downlink Control Information
DL Downlink
DM-RS Demodulation Reference Signal
DRB Data Radio Bearer
HARQ Hybrid Automatic Repeat Request
LTE Long Term Evolution e.g. from 3GPP LTE R8 and up
NACK Negative ACK
mTRP Multiple TRP
MCS Modulation and Coding Scheme
MIMO Multiple Input Multiple Output
NC-JT Non-Coherent Joint Transmission
NR New Radio
OFDM Orthogonal Frequency-Division Multiplexing
PHY Physical Layer
PMI Precoding Matrix Indicator
PRACH Physical Random Access Channel
PSS Primary Synchronization Signal
RACH Random Access Channel (or procedure)
RAR Random Access Response
RF Radio Front end
RLF Radio Link Failure
RLM Radio Link Monitoring
RNTI Radio Network Identifier
RRC Radio Resource Control
RRM Radio Resource Management
RS Reference Signal
RSRP Reference Signal Received Power
RSSI Received Signal Strength Indicator
SDU Service Data Unit
SRS Sounding Reference Signal
SS Synchronization Signal
SSS Secondary Synchronization Signal
SPS Semi-persistent scheduling
SUL Supplemental Uplink
TB Transport Block
TBS Transport Block Size
TRP Transmission/Reception Point
UL Uplink
URLLC Ultra-Reliable and Low Latency Communications
WLAN Wireless Local Area Networks and related technologies (IEEE 802.xx domain)
TDD Time Division Duplex
XDD Cross Division Duplex
FD Full Duplex
HD Half Duplex
IAB Integrated Access and Backhaul
SI Self-Interference
CLI Cross-Link Interference
PDSCH Physical Downlink Shared Channel
PUSCH Physical Uplink Shared Channel
PDCCH Physical Downlink Control Channel
PUCCH Physical Uplink Control Channel
CORESET Control Resource Set
SRS Sounding Reference Signal
UE User Equipment
PC Power Control
RB Resource Block
L1-RSRP Layer1-RSRP
cri-RSRP CSI-RS resource indicator-RSRP
SSB Synchronization Signal Block
SINR Signal-to-Interference-plus-Noise Ratio
TCI Transmission Configuration Indicator
OLPC Open Loop Power Control
CLPC Closed Loop Power Control
PL Pathloss
P-MPR Power Management-Maximum Power Reduction
PH Power Headroom
PHR Power Headroom Reporting
UCI Uplink Control Information
SRI SRS Resource Indicator
SL Sidelink (Side Link)
CRS Cell-specific RS

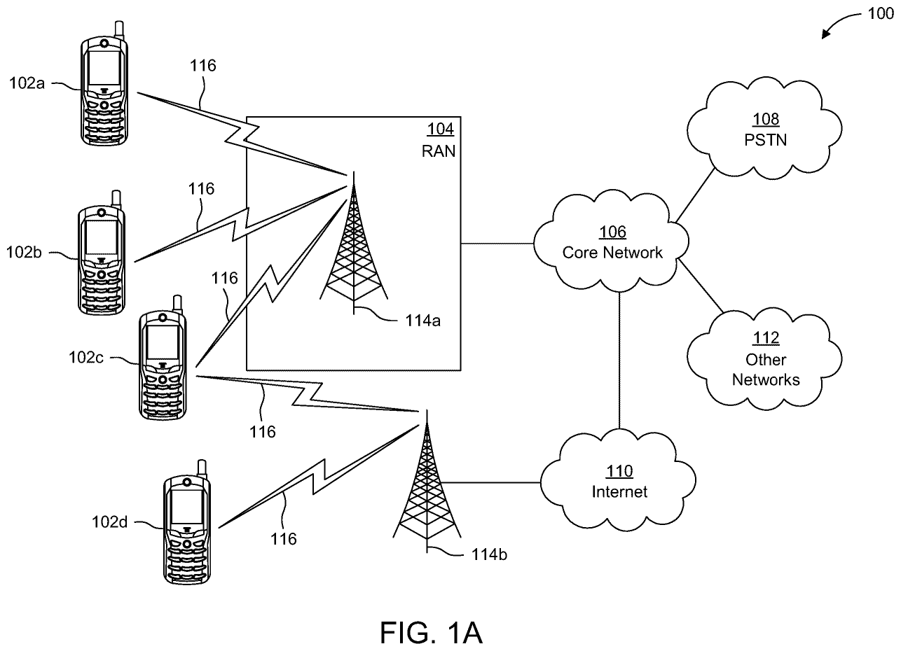

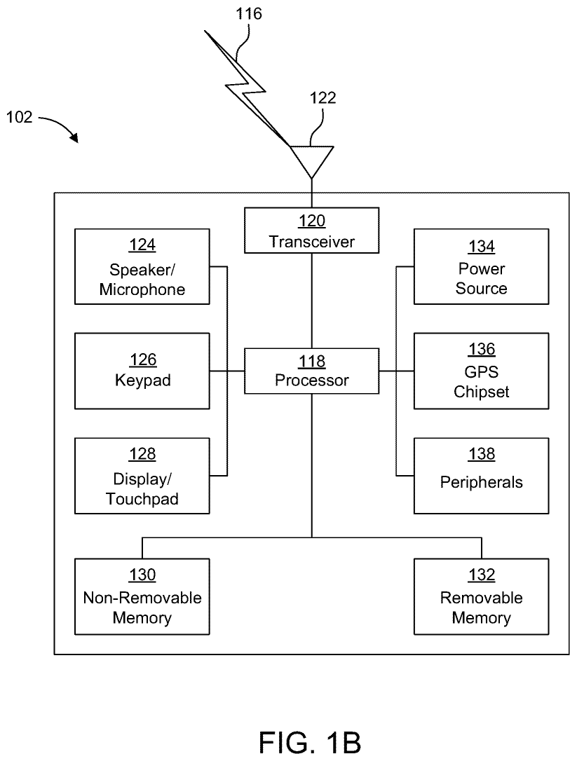

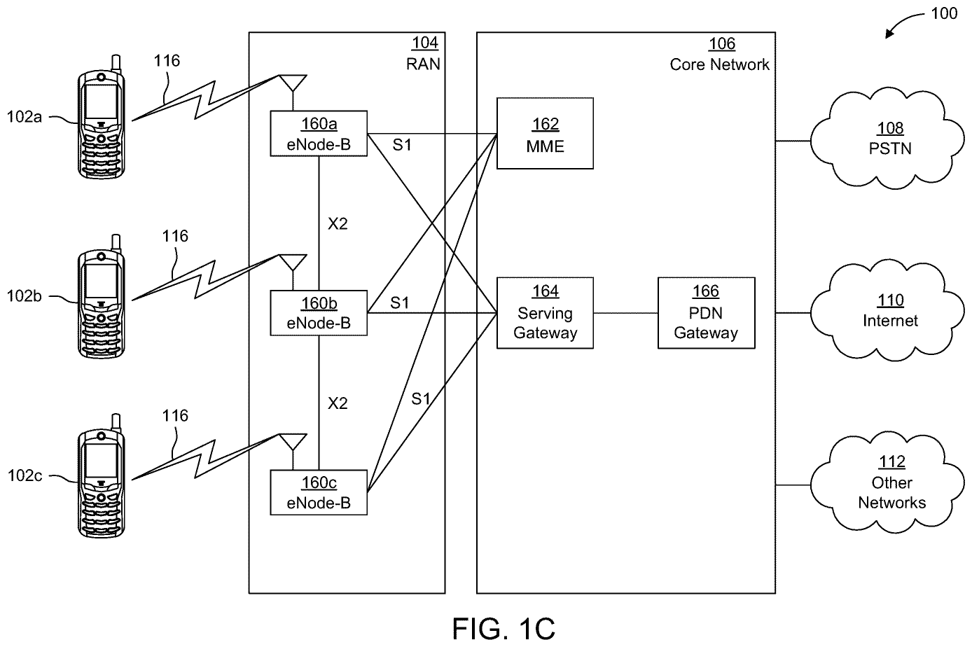

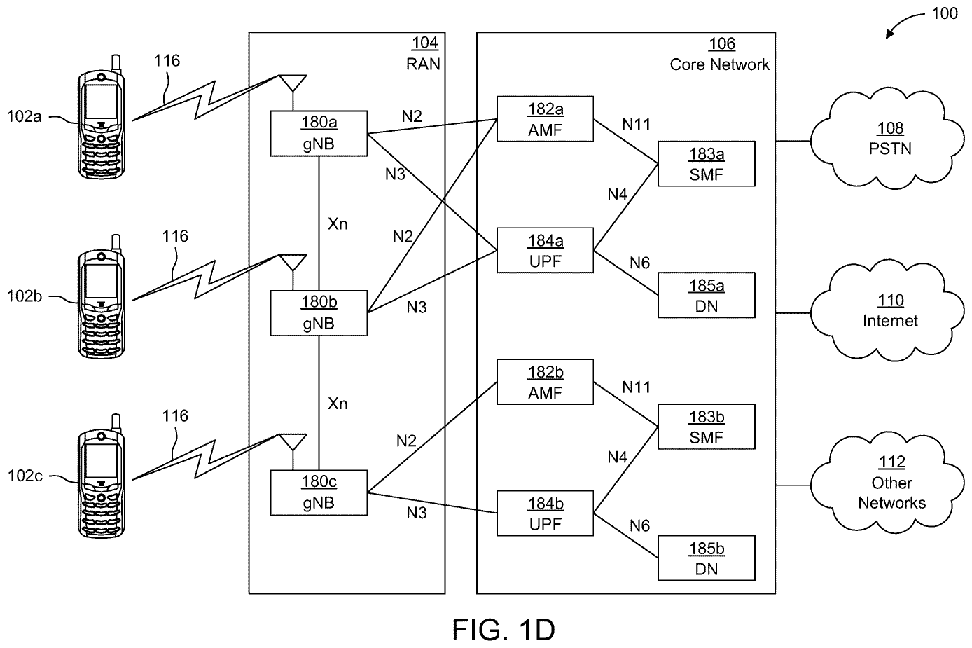

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In 5G wireless systems, duplexing technologies have been investigated based on a RAN work item on New Radio (NR) duplex operation, to improve conventional TDD operation by enhancing UL coverage, improving capacity, reducing latency, and so forth. The conventional TDD is based on splitting the time domain between the uplink and downlink. In NR Rel-19, the feasibility of allowing full duplex, or more specifically, subband non-overlapping full duplex (SBFD) at the gNB within a conventional TDD band is investigated.

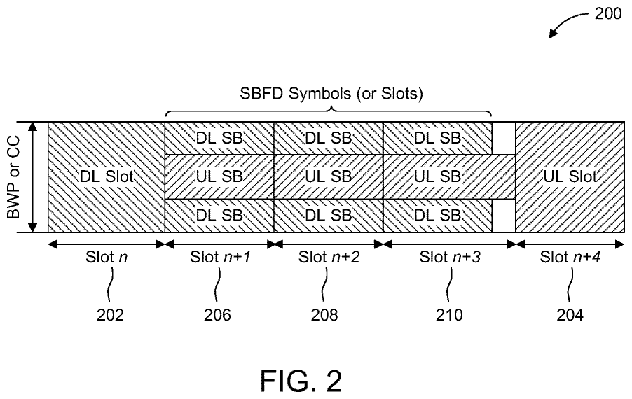

FIG. 2 illustrates and example of an SBFD configuration in TDD framework.

A WTRU may be configured with one or more types of slots within a bandwidth, wherein a first type of slot may be used or determined for a first direction (e.g., downlink, or sidelink (e.g., UE-to-UE communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction. Herein, the bandwidth may be interchangeably used with bandwidth part (BWP), carrier, sub-band, and system bandwidth; the first type of slot (e.g., the slot for a first direction) may be referred to as downlink (and/or sidelink) slot; the second type of slot (e.g., slot for a second direction) may be referred to as uplink (and/or sidelink) slot; the third type of slot may be referred to as Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)); the group of frequency resource for a first direction may be referred to as downlink (and/or sidelink) sub-band, downlink (and/or sidelink) frequency resource, or downlink (and/or sidelink) RBs; the group of frequency resource for a second direction may be referred to as uplink (and/or sidelink) sub-band, uplink (and/or sidelink) frequency resource, or uplink (and/or sidelink) RBs; the group of frequency resource for a flexible direction (e.g., that can be configured for a first direction, second direction, etc.) may be referred to as flexible sub-band, flexible frequency resource, or flexible RBs; and the group of frequency resource between a first direction and a second direction may be referred to as guard band, guard frequency resource, or guard RBs.

As illustrated in FIGS. 2, 202 is a dedicated DL slot, which is specifically allocated for DL transmissions, and slot 204 is a slot (n+4) a dedicated UL slot, which is specifically allocated in the UL direction. Slots 206-208 are SBFD slots. These slots include a first group of frequency resources within the bandwidth for a first direction and a second group of frequency resources within the bandwidth for a second direction. Slot n+1, 206, includes two groups of frequency resources in the DL direction and a group of frequency resources in a UL direction. Slot n+2, 208, and slot n+3, 210, also include two groups of frequency resources in the DL direction and a group of frequency resources in a UL direction.

In an example, a WTRU may be (pre)configured with one or multiple groups of frequency resources, where some groups of frequency resources are explicitly configured, and some are implicitly configured. For instance, the WTRU may be configured, e.g., within a cell or BWP, with a first group of frequency resources assigned to DL and a second group of resources assigned to UL as shown at 206-210 of FIG. 2. The WTRU may infer that the remaining group(s) of resources are used as guard band. Alternatively, the WTRU may receive a configuration including an UL sub-band and a guard band, and infer that the remaining resources are a DL sub-band, and so forth.

The realization of SBFD is subject to resolving the key challenges raised due to cross-link interferences (CLI). In an SBFD (or dynamic/flexible TDD) framework, a potential aggressor cell may switch from UL to DL or vice-versa, causing CLI on potential victim gNBs and UEs. In UL-to-DL CLI, the UL transmission from aggressor UEs may cause directional CLI at the victim UEs. The CLI can be measured at both the victim and/or aggressor UEs.

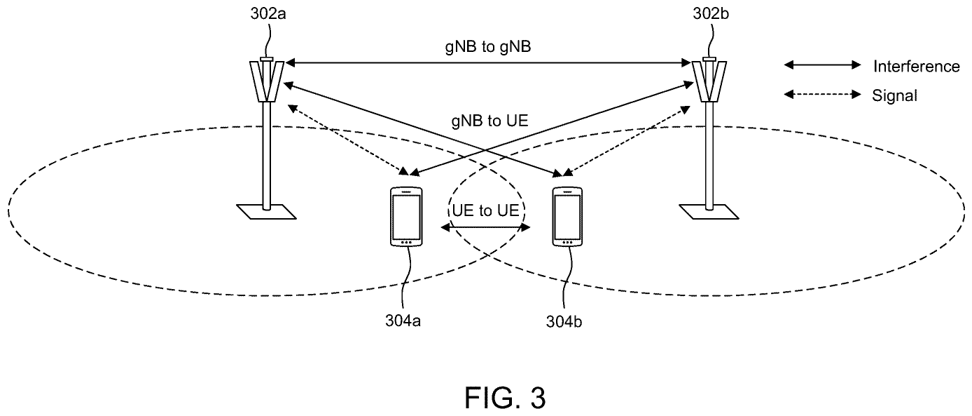

FIG. 3 illustrates examples of Cross Link Interference (CLI) including inter-gNB and inter-UE CLI.

In the example illustrated in FIG. 3, gNB 302a is actively serving WTRU 304a and gNB 302b is actively serving WTRU 302b. The UL/DL communication between gNB 302a and WTRU 304a may experience CLI due to signaling between gNB 302a and WTRU 304b, signaling between gNB 302b and WTRU 304a, and signaling between WTRU 304a and WTRU 204b. Likewise, the UL/DL communication between gNB 202b and WTRU 204b may experience from CLI due to signaling between gNB 302a and WTRU 304b, signaling between gNB 302b and WTRU 304a, and signaling between WTRU 204a and WTRU 204b. Each WTRU may be subject to different types of UL to DL CLI.

Intra-frequency, inter-cell (co-channel) CLI may occur when neighboring cells are configured with different link directions in the same carrier frequency, either for SBFD, dynamic/flexible TDD cases, (overlapping/in-band) Full Duplex, XDD, etc. Intra-frequency, inter-sub-band CLI, where an UL transmission (from the serving cell or a neighboring cell) in a SBFD sub-band creates leakage interference in the adjacent DL sub-band, for the SBFD scenario. Inter-frequency CLI, where the UL transmission in an adjacent frequency carrier (from the serving cell or a neighboring cell) creates leakage in the adjacent DL sub-band, for both SBFD and dynamic/flexible TDD scenarios.

In NR Rel-19, a special case of multi-point deployment is considered where unlike conventional systems, uplink and downlink transmissions are asymmetric (e.g., decoupled). In this deployment scenario, two different types of TRPs may be assumed, i.e., conventional TRPs with UL/DL capabilities and UL-only TRPs that are only capable of reception of the uplink signals. As such, no change of existing cell definition or defining may be required.

Since in such deployment, there may be no downlink transmission of any form from a UL-only cell, all DL transmissions may be strictly from the main TRP. A typical deployment consists of at least one TRP with both downlink and uplink transmission capabilities, and at least one receive-only point (ROP).

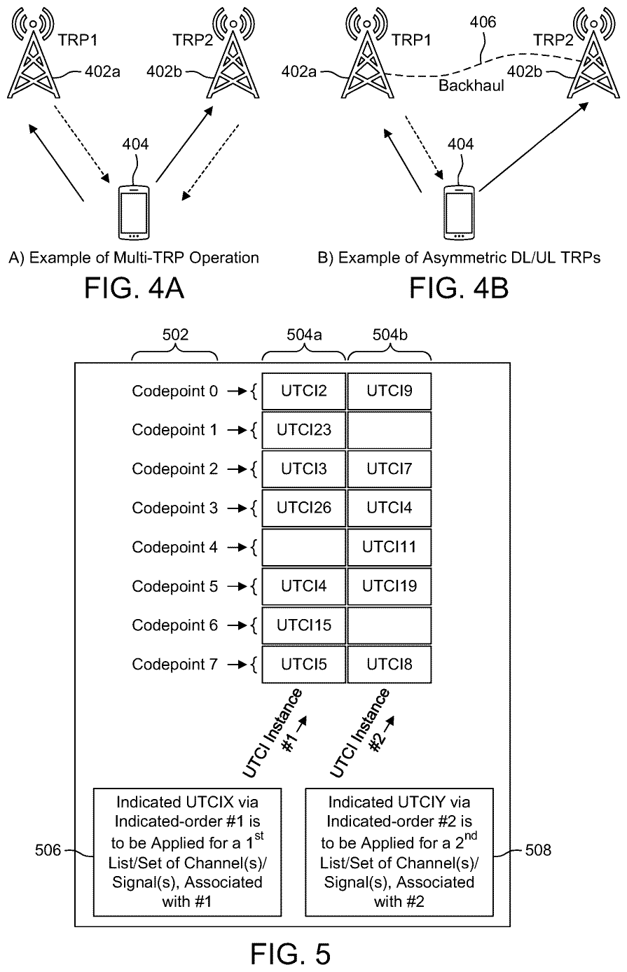

FIG. 4A is a high level system diagram illustrating a multi-TRP (Transmission and Reception Point) operation with a wireless transmit/receive unit (WTRU) 404 connected to multiple TRPs. The figure demonstrates a scenario where a WTRU communicates with two TRPs, TRP1 402a and TRP2 402b, which are part of the same network.

In this conventional setup, both TRP1 402a and TRP2 402b are capable of handling both DL and UL transmissions. The WTRU 404 receives DL signals from both TRPs and transmits UL signals back to them. This configuration allows for enhanced communication reliability and improved network performance by leveraging the combined capabilities of multiple TRPs.

The conventional multi-TRP operation depicted in FIG. 4A is typically used to improve coverage, increase data rates, and enhance overall communication quality. However, this setup assumes tightly coupled DL and UL operations, where the same TRP handles both transmission and reception for a given communication link. While effective in many scenarios, this approach may face challenges in managing interference, optimizing resource allocation, and addressing beam failure events in dynamic environments.

FIG. 4B is a high level system diagram illustrating an example of asymmetric downlink (DL) and uplink (UL) transmission/reception points (TRPs) connected via a backhaul 406. The figure demonstrates a scenario where a wireless transmit/receive unit (WTRU) 404 communicates with two separate TRPs, TRP1 402a and TRP2 402b, which are part of the same network but serve distinct functions. In this asymmetric configuration: TRP1 402a is dedicated to handling DL transmissions, optimized for high-power directional communication to the WTRU 404, and TRP2 402b is dedicated to handling UL receptions, optimized for sensitive reception of signals transmitted by the WTRU 404.

The two TRPs are connected via backhaul 406 (e.g., via an (almost) ideal backhaul, e.g., based on optical fiber, wired connection), which facilitates seamless coordination between the DL and UL operations. For example, TRP1 402a may be positioned to maximize DL coverage, while TRP2 402b may be strategically located to improve UL reception for cell-edge users.

The asymmetric DL/UL TRP configuration depicted in FIG. 4B addresses several challenges inherent in conventional multi-TRP setups, such as self-interference and mismatched spatial-domain properties between DL and UL beams. By separating the DL and UL functions, this architecture enables more efficient beam management, reduces latency, and enhances communication reliability in dynamic environments. This setup is particularly beneficial for next-generation wireless networks, such as those employing subband non-overlapping full duplex (SBFD) operations.

Once an ROP receives an uplink signal, after some basic initial processing, it may share the signal for further processing to the main TRP. The main benefit of ROP deployment is to improve uplink throughput, coverage, and reliability performance for cell edge UEs by mitigating limitations due to large pathloss and UE transmission power.

Furthermore, the multi-TRP deployment may comprise a first TRP for DL transmissions (only) and a second TRP for UL receptions (only), where such first and second TRPs (e.g., being connected via an (almost) ideal backhaul, e.g., based on optical fiber, etc.) may be regarded as “decoupled TRPs” in terms of DL and UL each served by a different TRP. This deployment scenario of decoupled TRPs, e.g., when combined with a duplex operation such as SBFD, may provide energy saving gains, reduce deployment cost, and/or facilitate such deployments thanks to significantly reduced downlink interference (e.g., self-interference affecting to UL receptions, e.g., at the second TRP).

One of the biggest challenges in SBFD systems is CLI affecting UL reception at a BS due to self-interference (SI) from the same BS's downlink transmission occurring simultaneously. To address the SI issue, implementing separate physical antenna panels, one for DL transmission and another for UL reception, has been considered as a potential implementation choice in practice. However, this requires a larger area for antenna deployment at the BS site. To mitigate this size constraint, an alternative approach is to separate the locations of DL and UL antenna panels, e.g., using decoupled DL/UL TRPs that are at least slightly geographically separated to sufficiently minimize SI effects. However, this approach may lead to a mismatch in Tx/Rx spatial-domain properties, such that beam correspondence between DL and UL directions when communicating with UEs may no longer hold.

In a decoupled DL/UL-TRP (e.g., asymmetric TRP) scenario, a beam failure detection (BFD) with corresponding criteria may not be clear on whether: both DL/UL beams satisfy the BFD criteria (e.g., UE movement/rotation, etc.), only the DL beam satisfies the BFD criteria (e.g., only DL beam blockage), etc., or only the UL beam satisfies the BFD criteria.

In an embodiment, a WTRU may receive configuration of two BFD-MAX-counter parameters (C and D, e.g., C=2, D=10). The WTRU checks whether the current DL-beam quality (of DL-TRP1 of a serving cell) satisfies a BFD criteria (e.g., whether the DL-beam quality is below a threshold for C times) and if so, the WTRU transmits a first-step BFRR (possibly more than once, e.g., until reaching a counter value such as D=10). The first-step BFRR is transmitted using a normal UL channel (e.g., PUSCH, PUCCH, MAC-CE) towards the UL-TRP2 (of the serving cell) using a current UL-beam and indicates a selected new DL-beam (q_new) from a candidate set (e.g., hoping that UL channel quality is OK although DL channel quality is below the threshold-DL-BFR only).

If the WTRU receives a NW-response (e.g., via DCI, via BFR-CORESET, and/or monitored using the indicated new DL beam) successfully, all counters C & D are reset, and the BFR was successfully completed (e.g., much earlier than reaching D=10) in such a decoupled UL/DL TRP scenario.

If a NW-response is not received until reaching the count D (e.g., implying UL channel quality is not OK either both DL&UL BFR), the WTRU transmits a second-step BFRR by transmitting PRACH using a new UL beam (for transmission to UL-TRP2 of the serving cell) determined by the WTRU based the selected new DL beam (q_new) and based on received information of association between DL-RSs such as SSBs (for the decoupled UL/DL TRP scenario) and based on determining a corresponding RO (associated with the selected DL-beam). The WTRU monitors a NW-response (RAR in this case), e.g., via the BFR-CORESET.

In an example embodiment, a WTRU perform one or more of the following operations.

The WTRU may receive configuration information, e.g., for hybrid beam failure recovery (BFR) method. The configuration may include at least one of: a first max-counter parameter (C), e.g., for a first-step BFR request (BFRR), e.g., C=2, information on an associated first UL channel type, e.g., PUSCH, PUCCH, MAC-CE, for delivering the first-step BFRR, when a first BFD criteria is satisfied (e.g., BFD counter reaches C); a second max-counter parameter (D), e.g., for a second-step BFRR, e.g., D=10 (>C), information on an associated second UL channel type, e.g., PRACH, for delivering the second-step BFRR, when a second BFD criteria is satisfied; a set of beam failure detection (BFD) RSs (e.g., a set q_0) and a first threshold; a set of candidate RSs (e.g., a set q_1) and a second threshold; a plurality of TCI-states (e.g., associated with a DL-TRP1), where a TCI-state corresponds to a DL RS (e.g., SSB, CSI-RS); a plurality of UL-TCI-states (e.g., associated with a UL-TRP2), where an UL-TCI-state corresponds to a DL-RS or an UL-RS (e.g., SRS); and one or more associations of DL and UL, each comprising a linkage between a DL reference (e.g., SSB, CSI-RS, TCI-state) applicable for DL-TRP1 and at least one UL reference (e.g., SSB, SRS, UL-TCI-state) applicable for UL-TRP2.

The WTRU may determine (or explicitly receives an indication of) a first UL-TCI-state (of the plurality of UL-TCI-states) applicable for UL transmissions (e.g., toward the UL-TRP2). The WTRU may determine a first UL spatial-domain filter (e.g., first UL beam) using the first UL TCI-state.

A first-step BFD operation based on a max-counter C, and corresponding first-step BFRR via PUCCH or PUSCH (e.g., MAC-CE) may be performed. The WTRU may determine a beam failure is detected (e.g., the first BFD criteria is satisfied, e.g., when measurements of one or more (e.g., all) the BFD RSs are below the first threshold C times) and selects a first DL RS (from the set of candidate RSs) that exceeds the second threshold. The WTRU may transmit (e.g., repeatedly transmits more than one time or re-transmits if allowed by a configuration by NW), using the first UL spatial-domain filter, a first-step BFRR at least comprising an ID of the selected first DL RS, via an available transmission occasion associated with the associated first UL channel type. This may bring benefits, e.g., for a case of only DL-TRP1 being blocked while UL-TRP2 is OK. For example, the WTRU may transmit the first-step BFRR via an available PUSCH transmission (e.g., MAC-CE) or a PUCCH transmission (e.g., a few bits to indicate the selected DL RS ID), and the WTRU may monitor for a response (e.g., a DCI or PDCCH) from the network (e.g., using a first spatial-domain filter determined by the selected first DL RS (q_new)).

In addition, a second-step BFD operation based on a max-counter D, and corresponding second-step BFRR via PRACH may be performed.

If a response from the network is not received during the time window for monitoring, the WTRU may determine the second BFD criteria is satisfied (e.g., when the BFD counter reaches D, a time window of D time units is exceeded, or a number of first-step BFRR transmission exceeds a count of D, etc.), and the WTRU may select a second DL RS (from the set of candidate RSs) that exceeds the second threshold. The selected second DL RS may be the same or different from the selected first DL RS.

Based on the one or more associations of DL and UL, the WTRU may determine a third RS (e.g., for a new UL beam targeted toward UL-TRP2) being linked to the second DL RS. The WTRU may determine a RACH occasion (RO) that is associated with the second DL RS and/or the third RS, and the WTRU may determine a second UL spatial-domain filter based on the third RS (e.g., for the new UL beam).

Based on the determinations, the WTRU may transmit, using the second UL spatial-domain filter, a PRACH over the RO, where the PRACH transmission (e.g., as the second-step BFRR, sent via the new UL beam toward UL-TRP2) is (implicitly) associated with reporting the newly found second DL RS (applicable for receptions from DL-TRP1).

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Hereinafter, the term “subband” is used to refer to a frequency-domain resource and may be characterized by at least one of the following: a set of resource blocks (RBs); a set of resource block sets (RB sets), e.g. when a carrier has intra-cell guard bands; a set of interlaced resource blocks; a bandwidth part, or portion thereof, or a carrier, or portion thereof.

For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” is used to refer to a subband-wise duplex (e.g., either UL or DL being used per subband) and may be characterized by at least one of the following: Cross Division Duplex (e.g., subband-wise FDD within a TDD band); Subband-based full duplex (e.g., full duplex as both UL and DL are used/mixed on a symbol/slot, but either UL or DL being used per subband on the symbol/slot); Frequency-domain multiplexing (FDM) of DL/UL transmissions within a TDD spectrum; a subband non-overlapping full duplex (SBFD) (e.g., non-overlapped sub-band full-duplex); a full duplex other than a same-frequency (e.g., spectrum sharing, subband-wise-overlapped) full duplex, or an advanced duplex method, e.g., other than (pure) TDD or FDD.

Hereinafter, the term “dynamic(/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, In a system employing dynamic/flexible TDD, a component carrier(CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-link interference (CLI).

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

A WTRU may receive transmit configuration indication (TCI) related configuration(s), e.g., comprising a plurality of TCI-states (e.g., an RRC-configured pool of TCI-states (e.g., as unified TCI framework), ‘TCI-State’ IE, ‘TCI-UL-State’ IE, ‘spatialRelationInfo’ IE, etc.). A TCI-state of the plurality of TCI-states may be associated (comprised) with at least one of QCL-info #1, QCL-info #2, additionalPCI, pathloss RS(PLRS)-ID, UL-PC, Timing Advance Group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop(CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command(TAC)(s)) in association with the TAG-ID (e.g., of multiple TAG-IDs being configured) to a scheduled UL transmission.

As an example, typeA may represent {Doppler shift, Doppler spread, average delay, delay spread}; typeB may represent {Doppler shift, Doppler spread}; typeC may represent {Doppler shift, average delay}; and typeD may represent {Spatial Rx parameter}.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

A unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter.

In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a CC. In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant/configured-grant based PUSCH and all (or subset of) dedicated PUCCH resources in a CC.

The WTRU may be configured with a first mode for unified TCI (e.g., Separate DL/UL TCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station(BS), a gNB, a TRP, etc.) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., Joint TCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a Coreset Pool identity (e.g., CORESETPoolIndex, a TRP indicator, and/or the like).

Hereafter, unified TCI may be interchangeably used with one or more of unified TCI-states, unified TCI instance, TCI, and TCI-state, but still consistent with this invention.

A WTRU may be configured with a plurality of transmission configuration indicator (TCI) states, e.g., unified TCI (UTCI) states, each applicable for multiple channel(s)/signal(s). The multiple channel(s)/signal(s) may be configured to the WTRU (or pre-determined or defined), e.g., in a form of a list, by a higher-layer signaling (e.g., RRC and/or MAC-CE) which may comprise at least one of following (e.g., as a combination): one or more CORESETs; one or more PDCCH candidates; one or more search spaces; one or more PDSCHs (e.g., PDSCH occasions/configurations/instances, etc.); one or more RSs (e.g., CSI-RSs, DMRSs, SSB indexes, PRSs, PTRSs, and/or SRSs); one or more PUSCHs (e.g., PUSCH occasions/configurations/instances, etc.); one or more PUCCH resources (e.g., PUCCH resource sets/groups); or one or more PRACH occasions/resources/RSs

The plurality of TCI states may be configured via an RRC signaling (e.g., and/or via a MAC-CE signaling, indication or activation). The WTRU may receive, e.g., via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

FIG. 5 example of a DCI field (e.g., TCI field) of a DCI for unified TCI-state indications.

FIG. 5 shows an example of the DCI field (e.g., TCI field) of a DCI for unified TCI-state indications. The WTRU may receive the mapping between a codepoint (of the DCI field) and one or more TCI states, illustrated in the figure, e.g., via a MAC-CE signaling. For example, Codepoint 2 is mapped to {UTCI3, UTCI7}, where the WTRU may apply at least one of {UTCI3, UTCI7} to the multiple channel(s)/signal(s), e.g., based on a list of the multiple channel(s)/signal(s) configurable by a higher-layer signaling from a gNB. In an example, the list of the multiple channel(s)/signal(s) may be given per UTCI instance (e.g., TCI-state group, a group of TCI-states, a set of activated TCI-states, associated with a TRP, associated with CORESET(s)), where the UTCI instance may correspond to each column of the mapping table, illustrated in the FIG. 5, between a codepoint and the one or more TCI states.

FIG. 5 includes multiple codepoints 502 (e.g., Codepoint 0, Codepoint 1, etc.), each representing a unique identifier for a specific configuration. These codepoints 502 are used to indicate which UTCI instance should be applied to a given set of channels or signals. UTCI Instances (504a, 504b): Each codepoint is mapped to one or more UTCI instances. For example: Codepoint 0 is mapped to UTCI 2 and UTCI 9; Codepoint 1 is mapped to UTCI 23.; Codepoint 2 is mapped to UTCI3 and UTCI7; Codepoint 3 is mapped to UTCI26 and UTCI4; Codepoint 4 is mapped to UTCI11.; Codepoint 5 is mapped to UTCI4 and UTCI19; Codepoint 6 is mapped to UTCI15; and Codepoint 7 is mapped to UTCI5 and UTCI8. Indicated Orders (506, 508): The figure also includes indicated orders (#1 and #2) that specify how the mapped UTCI instances are to be applied. For example: Indicated order #1 specifies that the UTCI instance mapped via Codepoint 0 is to be applied to a first list or set of channels/signals associated with #1, and Indicated order #2 specifies that the UTCI instance mapped via Codepoint 0 is to be applied to a second list or set of channels/signals associated with #2.

Hereafter, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Hereafter, Multi-TRP may be interchangeably used with one or more of MTRP, M-TRP, and multiple TRPs, but still consistent with this invention.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: CSI Report Configuration, CSI-RS Resource Set, and NZP CSI-RS Resources.

A CSI Report Configuration may include one or more of the following: CSI report quantity, e.g., Channel Quality Indicator (CQI), Rank Indicator (RI), Precoding Matrix Indicator (PMI), CSI-RS Resource Indicator (CRI), Layer Indicator (LI), etc., a CSI report type, e.g., aperiodic, semi persistent, periodic, a CSI report codebook configuration, e.g., Type I, Type II, Type II port selection, etc., and a CSI report frequency.

A CSI-RS Resource Set may include one or more of the following CSI Resource settings: NZP-CSI-RS Resource for channel measurement, NZP-CSI-RS Resource for interference measurement, and CSI-IM Resource for interference measurement.

NZP CSI-RS Resources may include one or more of the following: NZP CSI-RS Resource ID, Periodicity and offset, QCL Info and TCI-state, and Resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

Synchronization signal (SS) reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

Cross-link interference received signal strength indicator (CLI-RSSI) may be measured based on the average of the total power contribution in configured OFDM symbols of the configured time and frequency resources. The power contribution may be received from different resources (e.g., cross-link interference, co-channel serving and non-serving cells, adjacent channel interference, thermal noise, and so forth)

Sounding reference signals RSRP (SRS-RSRP) may be measured based on the linear average over the power contribution of the resource elements (RE) that carry the respective SRS.

In the following, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

In the following, an indication by DCI may consist of at least one of the following: an explicit indication by a DCI field or by RNTI used to mask CRC of the PDCCH or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Hereafter, a signal may be interchangeably used with one or more of following: Sounding reference signal (SRS); Channel state information-reference signal (CSI-RS); Demodulation reference signal (DM-RS); Phase tracking reference signal (PT-RS); or Synchronization signal block (SSB) consistent with this disclosure.

Hereafter, a channel may be interchangeably used with one or more of following: Physical downlink control channel (PDCCH); Physical downlink shared channel (PDSCH); Physical uplink control channel (PUCCH); Physical uplink shared channel (PUSCH); Physical random access channel (PRACH), etc. consistent with this disclosure.

Hereafter, downlink reception may be used interchangeably with Rx occasion, PDCCH, PDSCH, SSB reception, consistent with this disclosure.

Hereafter, uplink transmission may be used interchangeably with Tx occasion, PUCCH, PUSCH, PRACH, SRS transmission consistent with this disclosure.

Hereafter, RS may be interchangeably used with one or more of RS resource, RS resource set, RS port and RS port group consistent with this disclosure. Hereafter, RS may be interchangeably used with one or more of SSB, CSI-RS, SRS and DM-RS consistent with this disclosure. Hereafter, time instance may be interchangeably used with slot, symbol, subframe consistent with this disclosure. Hereafter, UTCI may be interchangeably used with TCI, UTCI state, TCI state consistent with this disclosure.

Hereafter, UL-only and DL-only Tx/Rx occasions may interchangeably be used with legacy TDD UL or legacy TDD DL, respectively consistent with this disclosure. In an example, the legacy TDD UL/DL Tx/Rx occasions may be the cases where SBFD is not configured and/or where SBFD is disabled. Hereinafter, the terms received signal power, received signal energy, received signal strength, SSB EPRE, CSI EPRE, RSRP, RSSI, SINR, RSRQ, SS-RSRP, SS-RSSI, SS-SINR, SS-RSRQ, CSI-RSRP, CSI-RSSI, CSI-SINR, and CSI-RSRQ may be used interchangeably consistent with this disclosure.

Hereafter, a UL signal (e.g., at least one of SRS, DMRS, PUSCH, PUCCH, PRACH, PTRS, etc.) may be used interchangeably with a UL signal or channel, or a UL channel or signal consistent with this disclosure.

Hereafter, a DL signal (e.g., at least one of CSI-RS, SSB, PDSCH, PDCCH, PBCH, PTRS, etc.) may be used interchangeably with a DL signal or channel, or a DL channel or signal consistent with this disclosure.

A WTRU may be configured with one or more types of slots within a bandwidth, wherein a first type of slot may be used or determined for a first direction (e.g., downlink, or sidelink (e.g., WTRU-to-WTRU communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction.

Herein, the bandwidth may be interchangeably used with bandwidth part (BWP), carrier, subband, and system bandwidth; the first type of slot (e.g., the slot for a first direction) may be referred to as downlink (and/or sidelink) slot; the second type of slot (e.g., slot for a second direction) may be referred to as uplink (and/or sidelink) slot; the third type of slot may be referred to as Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)); the group of frequency resource for a first direction may be referred to as downlink (and/or sidelink) subband, downlink (and/or sidelink) frequency resource, or downlink (and/or sidelink) RBs; the group of frequency resource for a second direction may be referred to as uplink (and/or sidelink) subband, uplink (and/or sidelink) frequency resource, or uplink (and/or sidelink) RBs; the group of frequency resource for a flexible direction (e.g., that can be configured for a first direction, second direction, etc.) may be referred to as flexible subband, flexible frequency resource, or flexible RBs; and the group of frequency resource between a first direction and a second direction may be referred to as guard band, guard frequency resource, or guard RBs.

In an example, a (SBFD-enabled) WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands.

For example, the SBFD configuration may include a flag signal (e.g., enabled/disabled), where for example a first value (e.g., zero (0)) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, RRC, MAC-CE, DCI, and so forth.

The WTRU may receive the time resources (e.g., one or more symbols, slots, and so forth), for which the first mode of operation (e.g., SBFD) is defined in for example one or more BWPs, subbands, component carriers (CC), cells, and so forth. The WTRU may receive the frequency resources (e.g., subbands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, MAC-CE, etc.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. subbands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In an example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

A WTRU may receive configurations of (e.g., may be configured with) SBFD subband time locations that may be configured within a period. In an example, the period may be the same as TDD-UL-DL pattern period configured by dl-UL-TransmissionPeriodicity, e.g., in TDD-UL-DL-ConfigCommon. In an (e.g., another) example, the period may be an integer multiple of TDD-UL-DL pattern period configured by dl-UL-TransmissionPeriodicity, e.g., in TDD-UL-DL-ConfigCommon.

When a (e.g., one, only one) TDD-UL-DL pattern is configured, SBFD symbols may be configured in consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

A WTRU may determine (or be indicated/configured with) that ‘UL usable PRBs’ are a part of UL subband frequency resources within an UL BWP (e.g., an active UL BWP, a currently active UL BWP), and ‘DL usable PRBs’ are a part of DL subband frequency resources within an DL BWP (e.g., an active DL BWP, a currently active DL BWP). The UL usable PRBs may be determined as an intersection between a configured or indicated UL subband and an active UL BWP in SBFD symbols (and/or slots). The DL usable PRBs may be determined as an intersection between a configured or indicated DL subband(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a subband boundary, the WTRU may determine that (only) the PRBs within DL usable PRBs are to be valid for PDSCH reception and (only) the PRBs within UL usable PRBs are to be valid for PUSCH transmission, e.g., where this may imply “partial RBG” is allowed and valid for resource allocation.

In an SBFD system, across SBFD symbols and non-SBFD symbols, it needs to be determined whether separate quasi co-location(QCL) and/or TCI-state configurations are applied or not, in consideration of different interference nature on different symbol types, e.g., due to non-negligible self-interference when using a DL beam on SBFD symbols.

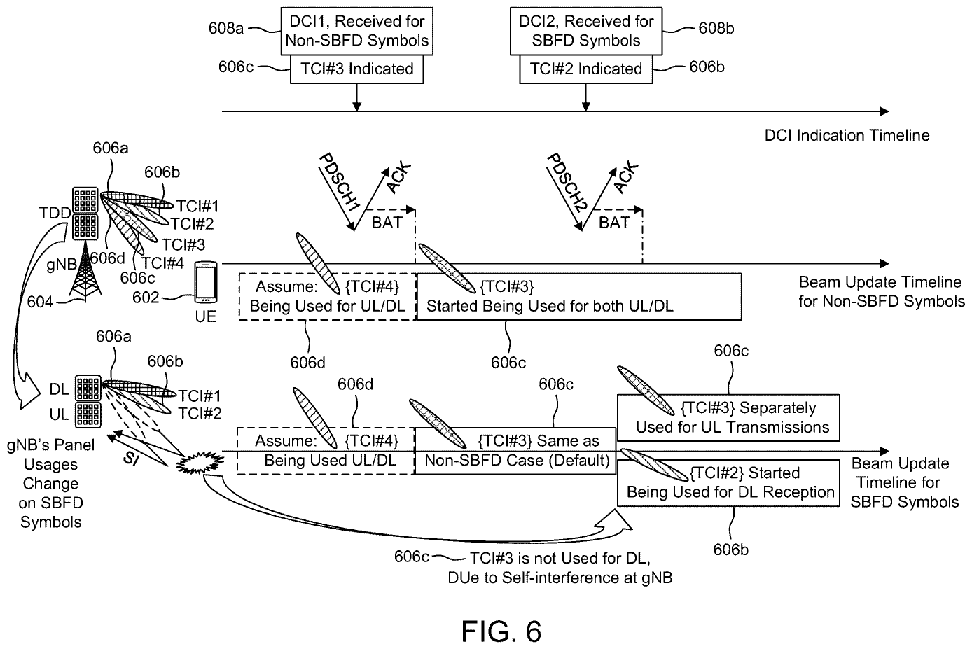

FIG. 6 illustrates an example of how to achieve such separated beam/TCI control across different SBFD symbol type in a single TRP scenario and under unified TCI (UTCI) framework. FIG. 6 includes a gNB 604, a UE 602, TCI #1 606a, TCI #2 606b, TCI #3 606c, TCI #4 606d, DCI1, Received for Non-SBFD Symbols (DRFNSS) 608a, and DCI2, Received for SBFD Symbols (DRFSS) 608b. The interactions between these components demonstrate the dynamic beam management and TCI state transitions in response to SBFD and non-SBFD symbol configurations.

WTRU 602 may receive configuration of a plurality of TCI-states. The WTRU may receive a TCI-activation command (e.g., via a MAC-CE) indicating (e.g., activating, updating, etc.) an activated set of TCI-states (e.g., TCI #1 606a, TCI #2 606b, TCI #3 606c, TCI #4 606d) among the plurality of TCI-states. In an example, the WTRU 602 may maintain (e.g., track, keep tracking) one or more quasi co-location (QCL) properties based on RSs within the activated set of TCI-states, where the one or more QCL properties may comprise at least one of {average delay, Doppler shift, delay spread, Doppler spread, spatial Rx, and/or average power}, e.g., upon receiving the TCI-activation command. In an example, the WTRU may not maintain (e.g., track) the QCL properties for an RS of a TCI-state (among the plurality of TCI-states) that is not activated by the TCI-activation command. The activated set of TCI-states may be ready for being used for a transmission or a reception when scheduled.

WTRU 602 may receive a first DCI (DCI1) 608a scheduling a first PDSCH (PDSCH1) (or without scheduling a PDSCH) and indicating a first TCI-state (e.g., TCI #3 606c) among the activated set of TCI-states. WTRU 602 may receive (e.g., decode, demodulate) the first PDSCH using TCI #X (e.g., X=4) that is a previously indicated TCI-state which may not be the same as the indicated TCI #3 606c. In response to receiving the first PDSCH (using TCI #4 606d), the WTRU may transmit an ACK (to a gNB) indicating a successful reception of the first PDSCH and/or a successful reception of the indicated first TCI-state (TCI #3 606c). The WTRU may (be configured to) start to apply the indicated first TCI-state (TCI #3 606c) T_BAT after transmitting the ACK, where a value of a beam application time (BAT), e.g., the T_BAT, may be configured by gNB 604. Until further receiving a second indicated TCI-state (e.g., by DCI2 608b), the WTRU may maintain (e.g., in terms of the QCL properties) the indicated first TCI-state (TCI #3 606c) for use of communications (for UL transmissions and/or DL receptions) with gNB 604.

The WTRU may determine that the reception of DCI1 608a or the first TCI state (TCI #3 606c) is associated with non-SBFD symbols, e.g., in terms of TCI/beam update. The determination may be based on an explicit indication from a gNB and/or based on an implicit rule, e.g., on condition of the symbol(s) where the DCI1 is received, which CORESET (and/or search space) the DCI1 is received, which RNTI the detected DCI1 is scrambled with, and so forth. Based on determining that the reception of DCI1 608a or the first TCI state (TCI #3 606c) is associated with non-SBFD symbols, the WTRU may update the indicated first TCI state (TCI #3 606c) for UL transmissions and/or DL receptions, e.g., at least for non-SBFD symbols, or for both non-SBFD symbols and SBFD symbols until a SBFD-specific TCI control command is received. In an example (e.g., by default), until (e.g., unless) a SBFD-specific TCI control command is received, the WTRU may use the first TCI state (TCI #3 606c) also in association with SBFD symbols, e.g., for UL transmissions and/or DL receptions. In an example, the WTRU may transmit a first UL channel or signal (e.g., PUSCH, PUCCH, SRS) using the first TCI state (TCI #3 606c), and/or receive a first DL channel or signal (e.g., PDSCH, PDCCH, CSI-RS) using the first TCI state (TCI #3 606c).

The WTRU may receive a second DCI (DCI2 608b) scheduling a second PDSCH (PDSCH2) (or without scheduling a PDSCH) and indicating a second TCI-state (e.g., TCI #2 606b) among the activated set of TCI-states. The WTRU may receive (e.g., decode, demodulate) the second PDSCH using a previously indicated TCI-state (which is TCI #3 606c indicated by DCI1 608a). In response to receiving the second PDSCH (using TCI #3 606c), the WTRU may transmit an ACK (to a gNB) indicating a successful reception of the second PDSCH and/or a successful reception of the indicated first TCI-state (TCI #2 606b). The WTRU may (be configured to) start to apply the indicated second TCI-state (TCI #2 606b) for at least one communication direction (e.g., DL), T_BAT2 after transmitting the ACK, where a BAT of T_BAT2 may be configured by the gNB and may be same as or independent from the T_BAT.

The WTRU may determine that the reception of DCI2 608b or the second TCI state (TCI #2 606b) is associated with SBFD symbols, e.g., in terms of TCI/beam update, where the reception of DCI2 608b may correspond to the SBFD-specific TCI control command. The determination may be based on an explicit indication from a gNB and/or based on an implicit rule, e.g., on condition of the symbol(s) where DCI2 608b is received, which CORESET (and/or search space) the DCI2 608b is received on, which RNTI the detected DCI2 608b is scrambled with, and so forth. Based on determining that the reception of DCI2 608b or the second TCI state (TCI #2 606b) is associated with SBFD symbols, the WTRU may update the indicated second TCI state (TCI #2 606b) for one communication direction (e.g., either UL transmission, or DL reception), where the one communication direction the WTRU applies for may be (pre-)configured or (separately) indicated by the gNB. In an example, based on determining that the reception of DCI2 608b or the second TCI state (TCI #2 606c) is associated with SBFD symbols, the WTRU may update the indicated second TCI state (TCI #2 608b) for DL receptions (e.g., on condition that the one communication direction is configured or indicated as a DL direction), e.g., while the WTRU may continue to use the first TCI state (TCI #3 606c) in association with SBFD symbols for UL transmissions. In an example, the WTRU may continue to use the first TCI state (TCI #3 606c) in association with non-SBFD symbols, e.g., for UL transmissions and/or DL receptions.

In an (e.g., another) example, based on determining that the reception of DCI2 608b or the second TCI state (TCI #2 606c) is associated with SBFD symbols, the WTRU may update the indicated second TCI state (TCI #2 606c) for (e.g., both) UL transmissions and/or DL receptions which the WTRU performs on SBFD symbol(s), while the WTRU may continue to use the first TCI state (TCI #3 606c) in association with non-SBFD symbols, e.g., for UL transmissions and/or DL receptions.

Based on receiving the SBFD-specific TCI control command (e.g., DCI2 608b), the WTRU may transmit a second UL channel or signal using the first TCI state (TCI #3 606c) on SBFD symbol(s) and/or non-SBFD symbol(s). The WTRU may receive a second DL channel or signal using the second TCI state (TCI #2 606b) on SBFD symbol(s), while the WTRU may receive a third DL channel or signal by using the first TCI state (TCI #3 606c) on non-SBFD symbol(s). This may provide benefits in terms of improving reliability in one communication direction performance (e.g., UL performance) while maintaining an optimized performance for another (e.g., the other) communication direction, e.g., when the gNB transmits a DL signal from a first gNB panel and simultaneously receives a UL signal at a second gNB panel, and some of DL beams (TCIs) (e.g., TCI #3 606c, TCI #4 606d) cause a self-interference (SI) on the UL reception, e.g., due to signal reflection, diffraction, by a clutter, obstacle, or by a non-ideal spatial-separation between the first and second gNB panels, etc.

A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (not both simultaneously at the given time). The WTRU may (also) operate in an FD mode for communicating with the gNB, e.g., if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD), spectrum-shared full duplex (SSFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within a configured SBFD subband, e.g., DL subband, usable DL PRBs) does not have an overlap with a second frequency-domain resource allocated for the second signal (e.g., assigned within a configured SBFD subband, e.g., UL subband, usable UL PRBs).

Hereafter, for the brevity of discussion, the FD operation may comprise the SBFD operation, however the solutions and examples in the disclosure may equally (or equivalently or extendedly, etc.) be employed (e.g., applicable) for cases with other FD operation types (e.g., IBFD, etc.).

A WTRU may receive SBFD-related configuration(s), e.g., for frequency-domain location information of one or more subbands (e.g., DL subband, UL subband, flexible DL/UL subband, and/or guard band), and/or for time-domain location information of the one or more subbands. The time-domain location information may indicate a set of non-SBFD symbols and a set of SBFD symbols (e.g., as illustrated in FIG. 2). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, e.g., depending on one or more conditions with other signal(s) co-existing in the symbol(s).

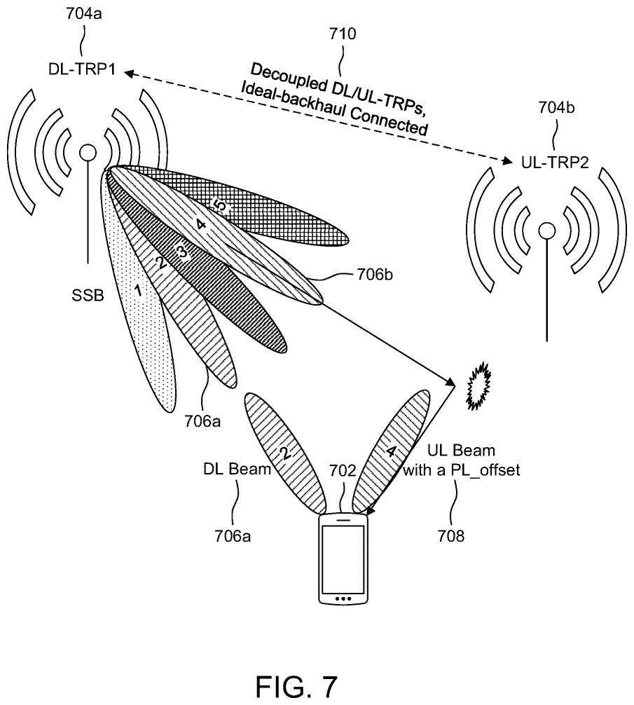

FIG. 7 illustrates an example of associations between a first SSB and one or more second SSBs.

FIG. 7 illustrates decoupled DL/UL-TRPs, backhaul 710, between DL-TRP1 704a, and UL-TRP2 704b, and respective beam configurations interacting with WTRU 702. Backhaul 710 enables decoupled downlink (DL) and uplink (UL) operations, facilitating efficient communication and beam management in next-generation wireless networks.

DL-TRP1 704a is dedicated to handling downlink transmissions, and UL-TRP2 704b is dedicated to handling uplink receptions. UL-TRP2 704b receives the uplink beam with a PL_offset 708, which is transmitted by WTRU 702. The PL_offset 708 incorporates a path loss offset to account for propagation conditions and ensure effective uplink communication.

A WTRU 702 may detect, e.g., during an initial access (random access), a first SSB (e.g., SSB #2 706a) where the first SSB may be transmitted from a first TRP 704a (e.g., TRP1, cell1, BS1, etc.). First TRP 704a may transmit DL channels or signals but may not receive any (e.g., all, some, a set of) UL channels or signals, where the first TRP may be associated with a second TRP 704b (e.g., TRP2, cell2, BS2, etc.) that is for receiving UL channels or signals. The association between first TRP 704a and second TRP 704b may be based on at least one of following components which may be separated (e.g., decoupled) between the TRPs, e.g., providing benefits in terms of network energy saving, interference reduction, reducing self-interference e.g. in a network operating a duplex scheme such as SBFD, and so on:

At least one communication direction, e.g., at least one among {DL, UL, sidelink(SL) for WTRU-to-WTRU communications, etc.}, for example, TRP1 704a may be dedicated for DL transmissions and TRP2 704b may be dedicated for UL receptions, e.g., in a form of strictly decoupled DL and UL TRPs.

TRP1 704a may be a main TRP (for both DL transmissions and UL receptions) and TRP2 704b may be dedicated for UL receptions, which may form a deployment scenario of asymmetric TRPs (asymmetric DL/UL TRPs). TRP1 704a may be dedicated for DL transmissions and TRP2 704b may be for both UL receptions and receptions of SL channels or signals. TRP1 704a may be for DL transmissions and transmissions of SL control signals and TRP2 704b may be for UL receptions and receptions of SL channels or signals (e.g., SL control signals from WTRU(s)).

At least one spatial-domain control, parameter(s), for example, communications with TRP1 (e.g., transmitting DL channels or signals) may be based on a first spatial-domain parameter (e.g., a first QCLed RS, a first QCL information component, a first TCI-state, a first RS of a first TCI-state, etc.), and communications with TRP2 (e.g., receiving UL channels or signals) may be based on a second spatial-domain parameter.

At least one frequency-domain resource allocation component, parameter(s), for example, communications with TRP1 (e.g., transmitting DL channels or signals) may be based on a first frequency-domain parameter, e.g., a first group of PRBs, a first cell, a first BWP, a first bandwidth, a first component carrier, a first DL subband (e.g., when a type of duplex operations is enabled such as SBFD, IBFD, SSFD), and communications with TRP2 (e.g., receiving UL channels or signals) may be based on a second frequency-domain parameter.

At least one time-domain resource allocation component, parameter(s), for example, communications with TRP1 (e.g., transmitting DL channels or signals) may be based on a first time-domain parameter, e.g., a first group of time units such as frames, subframes, slots, symbols, etc. (e.g., for (separate) interference management, for energy saving operations), a first symbol (or other time unit) type (e.g., SBFD symbol type, FD symbols, when a type of duplex operations is enabled such as SBFD, IBFD, SSFD), and communications with TRP2 (e.g., receiving UL channels or signals) may be based on a second time-domain parameter.

At least one power-domain control, parameter(s), for example, communications with TRP1 (e.g., transmitting DL channels or signals) may be based on a first power-domain parameter which may be for the WTRU to receive at least a part of the DL channels or signals (that may be applied by a DL transmission power adjustment, e.g., for interference management, for energy saving operations, and/or for duplex operation based on CLI mitigation, etc.), and communications with TRP2 (e.g., receiving UL channels or signals) may be based on a second spatial-domain parameter, e.g., a pathloss(PL) offset parameter(s), a UL power control related parameter, etc. For example, the WTRU may determine a UL transmission power level based on the PL offset parameter applied on a PL estimation performed on measuring a DL RS transmitted from the TRP1 (e.g., based also on the first power-domain parameter).

The WTRU may determine a first spatial-domain filter (e.g., spatial Rx (beam), spatial Tx (beam), spatial Rx and Tx beam based on beam correspondence or reciprocity property, spatial QCL reference, beam direction filter coefficients, etc.) being used for reception of the first SSB. The WTRU may, e.g., based on the first spatial-domain filter, receive configuration(s), e.g., via system information (broadcasted) based on (e.g., associated with) the detected SSB, comprising at least one of the following.

A plurality of synchronization signal block (SSB) indexes, e.g., via the system information, of a cell, a TRP (e.g., the TRP1), a BS, etc. A plurality of pathloss(PL)-offset parameters (values, e.g., in dB), e.g., PL-offset #1, 2, 3, 4, 5, 6, . . .

Information on pre-associations (e.g., signaled by SIB) between SSBs (of the plurality of SSBs) to be applied for a random access procedure, e.g., determining one or more RACH occasions (ROs) to transmit a PRACH upon detecting an SSB (e.g., the SSB #2 706a in FIG. 7).

The pre-associations may comprise: a first SSB index, e.g., SSB #2 (transmitted from DL-TRP1) and one or more second SSB indexes, e.g., SSB #4 (representing a geographically-separated UL-TRP2), where each of the one or more second SSB indexes may be mapped to a separate RO; a third SSB index, e.g., SSB #1 (transmitted from DL-TRP1) and one or more fourth SSB indexes, e.g., SSB #2, 3, 11, 12 (for UL-TRP 2), where each of the one or more fourth SSB indexes may be mapped to a separate RO, etc.

A default association (e.g., for SSB(s) that is not configured with (e.g., not a part of) the pre-associations) may be defined or configured such that the same SSB index is used for a PRACH transmission and/or RO determination. In an example, a default association may comprise, for example: SSB #3 (transmitted from DL-TRP1) and SSB #3 (for UL-TRP2, e.g., where (almost) same Rx/Tx beam determined based on SSB #3 may be used for a PRACH transmission toward UL-TRP2); SSB #4 (transmitted from DL-TRP1) and SSB #4 (for UL-TRP2, e.g., where (almost) same Rx/Tx beam determined based on SSB #4 may be used for a PRACH transmission toward UL-TRP2); and so on (e.g., for any SSB #X that is not configured with (e.g., not a part of) the aforementioned pre-associations)

Mapping information between an SSB and a PL-offset, where each of the one or more second (or fourth) SSB indexes may be associated with (e.g., linked to, mapped to) a corresponding PL offset which is used for determining a PRACH power (in consideration of a proper Tx power level determination for the geographically-separated UL-TRP2).

For example, each of the one or more of the second (or fourth) SSBs may further have its association to a PL-offset, for example, SSB #4 is associated with PL-offset #1, SSB #2 is associated with PL-offset #5, SSB #3 is associated with PL-offset #6, SSB #11, 12 is (commonly) associated with PL-offset #9 etc.

Information related to SSB-to-RO mapping rule, e.g., SSB #1 maps to RO #1, SSB #2 maps to RO #2, etc., where each RO (e.g., being not overlapped with any other ROs, or being allowed to overlap with second RO(s) and applying a configured priority rule to determine which RO to use when such overlap occurs) represents a time and frequency location of the RO over which the WTRU may transmit a PRACH.

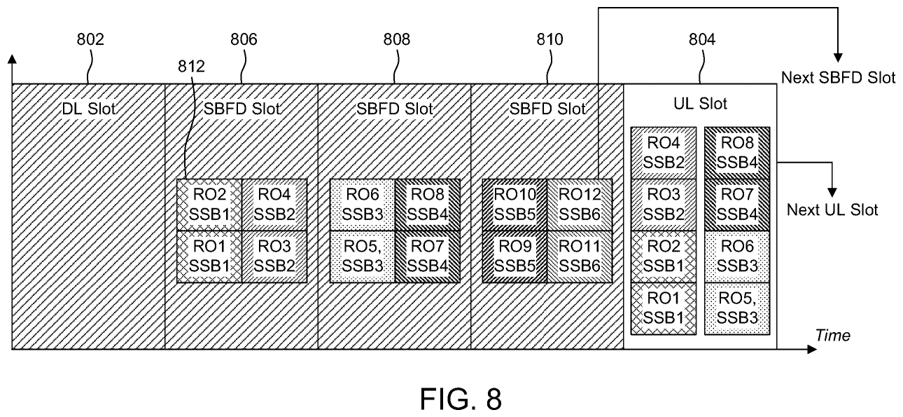

FIG. 8 illustrates an example of SSB-RO mapping with ascending order of SSB indexes in ROs.

FIG. 8 illustrates time-domain slot configurations, including DL Slot 802, UL Slot 804, and SBFD Slots 806, 808, and 810, with associated random access occasions (ROs) and synchronization signal blocks (SSBs) 812. In an example, a first SSB-to-RO mapping rule (e.g., in UL slot or in SBFD slots) may be based on ascending order of SSB indexes 1-to-M (M=1, 2, . . . configurable) mapped to (valid) ROs, e.g., by mapping frequency-domain first and time-domain second, as illustrated in FIG. 8 with an example of a configured FDM parameter M=2. This may result in the following SSB-to-RO mapping (based on examples of FIG. 8 with M=2):bSSB #1 maps to RO #1 and RO #2; SSB #2 maps to RO #3 and RO #4; SSB #3 maps to RO #5 and RO #6 . . . SSB #K (e.g., K=16 in the cell1, TRP1, BS1) maps to RO #{2K−1} and RO #{2K}. Where in this example, a total 2K ROs (32 ROs due to K=16) are mapped in a full cycle of SSB-to-RO mapping, and the WTRU may transmit a PRACH out of the 2K different PRACH transmission occasions.

In an example, based on the information on pre-associations such as SSB #1 being pre-associated with SSB #2, 3, 11, 12 (for UL-TRP 2) each being mapped to a separate RO, the WTRU may determine a second SSB-to-RO mapping rule (even though the same M=2 and K=16 are given) resulting in the following SSB-to-RO mapping: SSB #1 maps to RO #1&2 (pre-associated with SSB #2), RO #3&4 (pre-associated with SSB #3), RO #5&6 (pre-associated with SSB #11), and RO #7&8 (pre-associated with SSB #12); SSB #2 maps to RO #9&10 (pre-associated with SSB #4); SSB #3 maps to at least RO #11&12 (pre-associated with at least SSB #X, where X may be 3, e.g., based on the default association); and SSB #4 maps to at least RO #13&14 (pre-associated with at least SSB #Y, where Y may be 4, e.g., based on the default association) etc.

Where in this example, more than 2K ROs (more than 32 ROs due to K=16 and at least the case of SSB #1 mapped to 8 ROs based on the pre-associated SSB #2, 3, 11, 12 to have separate PRACH transmission occasions for each of pre-associated SSBs) may be mapped in a full cycle of SSB-to-RO mapping, and the WTRU may transmit one or more PRACHs out of more than 2K different PRACH transmission occasions. In an example, on condition that the WTRU detects the SSB #1 from DL-TRP1, the WTRU may (be configured to) transmit more than one PRACH (e.g., all or a subset of 8 PRACHs, e.g., based on one or more configured conditions or rules) out of the 8 ROs based on the pre-associated SSB #2, 3, 11, 12.

The configuration may include Full-duplex (FD) related information, e.g., SBFD subband time and/or frequency locations. The FD related information may include: time/frequency location information on one or more DL subbands (for reception, e.g., from DL-TRP #1), for example, 1st DL subband spans over a 1st set of PRBs, or 2nd DL subband spans over a 2nd set of PRBs; time/frequency location information on one or more UL subbands (for transmission, e.g., toward UL-TRP #2), for example, 1st UL subband spans over a 3rd set of PRBs.

In an example, the WTRU may detect the first SSB index (e.g., SSB #2, transmitted from the DL-TRP1), e.g., within a DL subband (spanning over either the 1st set of PRBs or the 2nd set of PRBs), configured for the DL-TRP1. The WTRU may determine to use RO #9 and/or RO #10 (pre-associated with SSB #4, based on a configuration or indication, based on the above example) to transmit one or more PRACHs, e.g., within a UL subband (spanning over the 3rd set of PRBs). Based on the determination, the WTRU may transmit a first PRACH on RO #9 and a second PRACH on RO #10, e.g., within the UL subband (spanning over the 3rd set of PRBs).

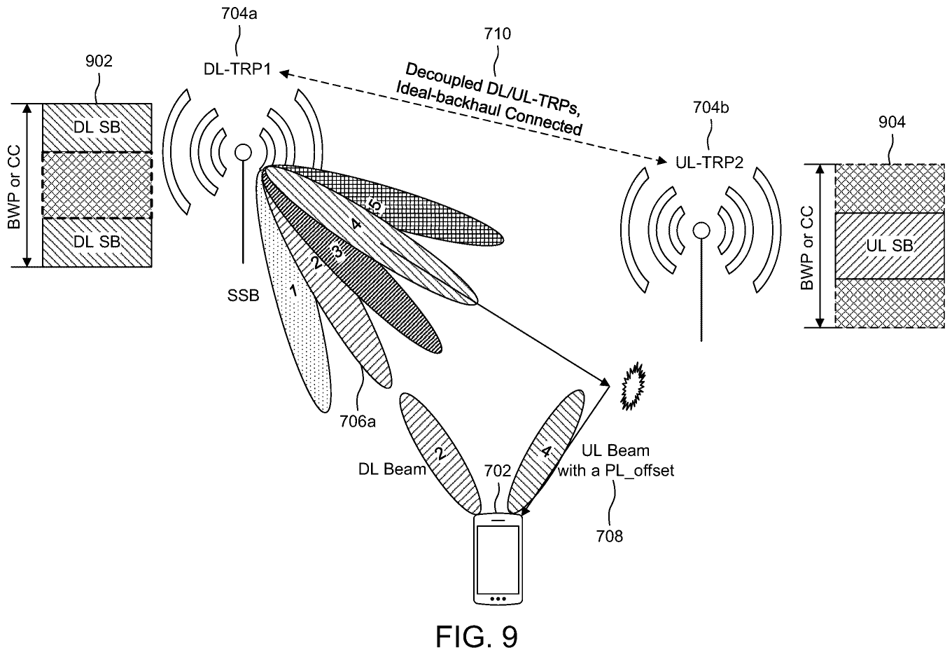

FIG. 9 illustrates an example of associations between a first SSB and one or more second SSBs in an SBFD system. FIG. 9 shows decoupled DL/UL-TRPs, backhaul 710, between DL-TRP1 704a, and UL-TRP2 704b, and respective beam configurations interacting with WTRU 702. Backhaul 710 enables decoupled downlink (DL) and uplink (UL) operations, facilitating efficient communication and beam management in next-generation wireless networks.

The WTRU may determine, based on the pre-associations, the one or more second SSB indexes (e.g., SSB #4 706c) being associated with the detected first SSB index (e.g., SSB #2 706b ), e.g., as illustrated in FIG. 7 and FIG. 9. The WTRU may determine a second spatial-domain filter (e.g., spatial Rx (beam), spatial Tx (beam), spatial Rx and Tx beam based on beam correspondence or reciprocity property, spatial QCL reference, beam direction filter coefficients, etc.) associated with (e.g., being used for receiving or measuring) the SSB #4. In an example, the second spatial-domain filter may be used for a UL transmission (e.g., a corresponding PRACH transmission toward the UL-TRP2 in response to detecting the first SSB index), where an actual transmission direction may point to an opposite (beam) direction based on the second spatial domain filter determined by measuring the SSB4, e.g., based on or according to the beam correspondence or reciprocity property.

The WTRU may determine a corresponding RO index based on (e.g., mapped to) the detected SSB #2 and/or determined pre-associated SSB #4, where such SSB-to-RO mapping rule may be configured or indicated. In an example, the corresponding RO index may be RO #9 and/or RO #10 based on the aforementioned examples of SSB-to-RO mapping, as follows: SSB #1 maps to RO #1&2 (pre-associated with SSB #2), RO #3&4 (pre-associated with SSB #3), RO #5&6 (pre-associated with SSB #11), and RO #7&8 (pre-associated with SSB #12); SSB #2 maps to RO #9&10 (pre-associated with SSB #4); SSB #3 maps to at least RO #11&12 (pre-associated with at least SSB #X, where X may be 3, e.g., based on the default association); and SSB #4 maps to at least RO #13&14 (pre-associated with at least SSB #Y, where Y may be 4, e.g., based on the default association).

The WTRU (in response to detecting the SSB #2) may transmit a PRACH (e.g., Msg1, toward the UL-TRP2) by using the second spatial-domain filter (determined based on SSB #4 being pre-associated with the SSB #2) and on the determined RO (e.g., RO #9 and/or RO #10). The WTRU may determine a Tx power of the PRACH based on the associated PL-offset parameter(s) (e.g., PL-offset #1 associated with the SSB #4, being pre-associated with SSB #2), and/or one or more PRACH power control related parameters such as {P_{CMAX} (e.g., possible maximum power), PreambleReceivedTargetPower (e.g., desired received power level at the BS, e.g., in [dB]), PowerRampingStep (e.g., used for each retransmission (re-attempt) of the PRACH transmission with a power ramping function), etc.}. In an example, the WTRU may determine the PRACH Tx power level based on the associated PL-offset (e.g., Q [dB] indicated based on the PL-offset #1) plus a determined Tx power level based on the one or more PRACH power control related parameters. The WTRU (in response to detecting the SSB #2) may transmit the PRACH on the determined RO(s) (e.g., RO #9 and/or 10) by using the determined PRACH Tx power level and the second spatial-domain filter.

In an example, the WTRU may (be configured to) determine whether the RO #9 and/or RO #10 is within the 1st UL subband (configured for the UL-TRP2). In an example, the WTRU may transmit the PRACH on the RO #9 and/or RO #10 on condition that the RO #9 and/or RO #10 is within the 1st UL subband (configured for the UL-TRP2), e.g., when the RO #9 is only within the 1st UL subband, the WTRU may transmit the PRACH on the RO #9 and not transmit the PRACH on the RO #10.

The WTRU may receive a random-access response (RAR) (e.g., Msg2, transmitted from the DL-TRP1, e.g., on either the 1st or 2nd DL subband) by using the first spatial-domain filter, where the RAR may comprise a scheduling grant for a PUSCH transmission. In an example, the WTRU may receive a DCI and the RAR scheduled by the DCI, where the RAR may comprise a RA preamble identifier (matched to the transmitted PRACH), a temporary C-RNTI (TC-RNTI), a timing advance command, a UL grant of the PUSCH (Msg3) for WTRU to transmit, and/or one or more parameters indicating which transmitted PRACH(s) and/or which RO(s) are the RAR is referring (e.g., responding, pointing) to.

Based on the RAR, the WTRU may transmit the PUSCH (e.g., Msg3, toward the UL-TRP2) by using the second spatial-domain filter, e.g., where the WTRU may determine a valid resource for the PUSCH is within the 1st UL subband. In an example, the WTRU may transmit the PUSCH (e.g., RRC connection request, e.g., Msg3) or an associated UL transmission, scheduled by the UL grant (given by the RAR).

The WTRU may receive a RRC setup message (e.g., Msg 4, transmitted from the DL-TRP1, on either the 1st or 2nd DL subband) by using the first spatial-domain filter. In an example, based on using the first spatial-domain filter, the WTRU may receive a second DCI and a PDSCH (e.g., RRC setup message, e.g., Msg4) scheduled by the second DCI.

The WTRU may transmit an ACK (e.g., Msg5) in response to the RRC setup message by using the second spatial-domain filter. In an example, based on using the second spatial-domain filter, the WTRU may transmit a second PUSCH (e.g., Msg5) or an associated UL transmission, indicated by the PDSCH (e.g., Msg4).

In an embodiment, a WTRU receives configuration of two BFD-MAX-counter parameters (C and D, e.g., C=2, D=10). The WTRU checks whether the current DL-beam quality (of DL-TRP1 of a serving cell) satisfies a BFD criteria (e.g., whether the DL-beam quality is below a threshold for C times) and if so, the WTRU transmits a first-step BFRR (possibly more than once, e.g., until reaching a counter value such as D=10). The first-step BFRR is transmitted using a normal UL channel (e.g., PUSCH, PUCCH, MAC-CE) towards the UL-TRP2 (of the serving cell) using a current UL-beam and indicates a selected new DL-beam (q_new) from a candidate set (e.g., hoping that UL channel quality is OK although DL channel quality is below the threshold-DL-BFR only).

If the WTRU receives a NW-response (e.g., via DCI, via BFR-CORESET, and/or monitored using the indicated new DL beam) successfully, all counters C & D are reset, and the BFR was successfully completed (e.g., much earlier than reaching D=10) in such a decoupled UL/DL TRP scenario.

If a NW-response is not received until reaching the count D (e.g., implying UL channel quality is not OK either, for example both DL&UL BFR), the WTRU transmits a second-step BFRR by transmitting PRACH using a new UL beam (for transmission to UL-TRP2 of the serving cell) determined by the WTRU based the selected new DL beam (q_new) and based on received information of association between DL-RSs such as SSBs (for the decoupled UL/DL TRP scenario) and based on determining a corresponding RO (associated with the selected DL-beam). The WTRU monitors a NW-response (RAR in this case), e.g., via the BFR-CORESET.

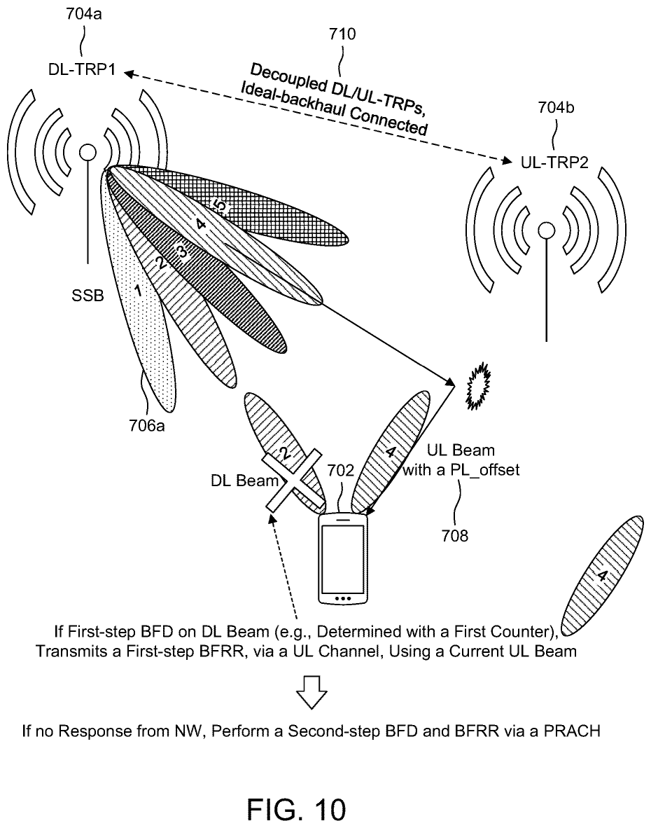

FIG. 10 illustrates an example of a hybrid BFR method based on multi-step BFR requests.

Decoupled DL/UL-TRPs are illustrated in FIG. 10. The decoupled UL/DL TRPs may communicate via backhaul 710. DL-TRP1 704a, UL-TRP2 704b, and their respective beam configurations interact with WTRU 702. DL-TRP1 704a is dedicated to handling downlink transmissions. DL-TRP1 704a generates DL Beams, for example 706a, which is directed toward WTRU 702 to establish a DL communication link. Additionally, DL-TRP1 704a transmits synchronization signal blocks (SSBs) to assist WTRU 702 in beam alignment and network synchronization.

UL-TRP2 704b is dedicated to handling uplink receptions. UL-TRP2 704b may receive the uplink beam with a PL_offset 708, which is transmitted by WTRU 702. PL_offset 708 incorporates a path loss offset to account for propagation conditions and ensure effective uplink communication.

WTRU 702 is a wireless transmit/receive unit that communicates with both DL-TRP1 704a and UL-TRP2 704b. WTRU 702 receives DL Beam 706a and SSBs from DL-TRP1 704a, enabling downlink communication and synchronization. WTRU 702 transmits an UL Beam with a PL_offset 708 to UL-TRP2 704b, facilitating uplink communication.

In an example embodiment, a WTRU perform one or more of the following, e.g., based on the examples illustrated in FIG. 10:

The WTRU may receive configuration information, e.g., for a hybrid beam failure recovery (BFR) method. The configuration may include at least one of: a first max-counter parameter (C), e.g., for a first-step BFR request (BFRR), for example, C=2, information on an associated first UL channel type, e.g., PUSCH, PUCCH, MAC-CE, for delivering the first-step BFRR, when a first BFD criteria is satisfied (e.g., BFD counter reaches C); a second max-counter parameter (D), e.g., for a second-step BFRR, e.g., D=10 (>C), information on an associated second UL channel type, for example, PRACH, for delivering the second-step BFRR, when a second BFD criteria is satisfied; a set of beam failure detection (BFD) RSs (e.g., a set q_0) and a first threshold; a set of candidate RSs (e.g., a set q_1) and a second threshold; a plurality of TCI-states (e.g., associated with a DL-TRP1), where a TCI-state corresponds to a DL RS (e.g., SSB, CSI-RS); a plurality of UL-TCI-states (e.g., associated with a UL-TRP2), where an UL-TCI-state corresponds to a DL-RS or an UL-RS (e.g., SRS); and one or more associations of DL and UL, each comprising a linkage between a DL reference (e.g., SSB, CSI-RS, TCI-state) applicable for DL-TRP1 and at least one UL reference (e.g., SSB, SRS, UL-TCI-state) applicable for UL-TRP2.

The WTRU may determine (or explicitly receives an indication of) a first UL-TCI-state (of the plurality of UL-TCI-states) applicable for UL transmissions (e.g., toward the UL-TRP2). The WTRU may determine a first UL spatial-domain filter (e.g., first UL beam) using the first UL TCI-state.

A first-step BFD operation based on a first max-counter C, and corresponding first-step BFRR via PUCCH or PUSCH (e.g., MAC-CE) may be performed. The WTRU may determine a beam failure is detected (e.g., the first BFD criteria is satisfied, e.g., when measurements of one or more (e.g., all) the BFD RSs are below the first threshold C times) and selects a first DL RS (from the set of candidate RSs) that exceeds the second threshold. The WTRU may transmit (e.g., repeatedly transmits more than one time or re-transmits if allowed by a configuration by NW), using the first UL spatial-domain filter, a first-step BFRR at least comprising an ID of the selected first DL RS, via an available transmission occasion associated with the associated first UL channel type. This may bring benefits, e.g., for a case of only DL-TRP1 being blocked while UL-TRP2 is OK. For example, the WTRU may transmit the first-step BFRR via an available PUSCH transmission (e.g., MAC-CE) or a PUCCH transmission (e.g., a few bits to indicate the selected DL RS ID), and the WTRU may monitor for a response (e.g., a DCI or PDCCH) from the network (e.g., using a first spatial-domain filter determined by the selected first DL RS (q_new)).

In addition, a second-step BFD operation based on a second max-counter D, and corresponding second-step BFRR via PRACH may be performed. If a response from the network is not received during the time window for monitoring, the WTRU may determine the second BFD criteria is satisfied (e.g., when the BFD counter reaches D, a time window of D time units is exceeded, or a number of first-step BFRR transmission exceeds a count of D, etc.), and the WTRU may select a second DL RS (from the set of candidate RSs) that exceeds the second threshold. The selected second DL RS may be the same or different from the selected first DL RS.

Based on the one or more associations of DL and UL, the WTRU may determine a third RS (e.g., for a new UL beam targeted toward UL-TRP2) being linked to the second DL RS. The WTRU may determine a RACH occasion (RO) that is associated with the second DL RS and/or the third RS, and the WTRU may determine a second UL spatial-domain filter based on the third RS (e.g., for the new UL beam).

Based on the determinations, the WTRU may transmit, using the second UL spatial-domain filter, a PRACH over the RO, where the PRACH transmission (e.g., as the second-step BFRR, sent via the new UL beam toward UL-TRP2) is (implicitly) associated with reporting the newly found second DL RS (applicable for receptions from DL-TRP1).

In an example embodiment, a WTRU may receive configurations, e.g., for hybrid BFR (or link failure recovery) method, comprising at least one of a first set of event-evaluation-parameter(s) (EEP), a second set of EEPs, and so on, a set of beam failure detection (BFD) RSs (e.g., a set ‘q_0’) with a first threshold, a set of candidate RSs (e.g., a set q_1) with a second threshold, a plurality of TCI-states (e.g., associated with a DL-TRP1) where a TCI-state may correspond to a DL RS (e.g., SSB, CSI-RS), a plurality of UL-TCI-states (e.g., associated with a UL-TRP2) where a UL-TCI-state may correspond to a DL-RS or an UL-RS (e.g., SRS), and one or more associations of DL and UL.

The first set of EEPs may comprise a first max-counter parameter (C), e.g., for a first-step BFR request (BFRR), e.g., C=2, and/or information on an associated first UL channel type, e.g., PUSCH, PUCCH, MAC-CE, for delivering the first-step BFRR, when a first BFD criteria is satisfied (e.g., when BFD counter reaches C). The first set of EEPs may comprise first parameter(s) on whether and/or how to declare a first-step “link failure” (e.g., “beam failure”), e.g., conditioned on how many time (in a row) and/or within a configured evaluation window the link (e.g., beam) failure events occur such that a measured quality is below the first threshold.

The second set of EEPs may comprise a second max-counter parameter (D), e.g., for a second-step BFR request (BFRR), e.g., D=10 (>C), and/or information on an associated second UL channel type, e.g., PRACH, for delivering the second-step BFRR, when a second BFD criteria is satisfied (e.g., the BFD counter reaches D, a time window of D time units is exceeded, or a number of first-step BFRR transmission exceeds a count of D, and so on). The second set of EEPs may comprise second parameter(s), e.g., which may be set independently from the first parameter(s), on whether and/or how to declare a second-step “link failure” (e.g., “beam failure”), e.g., conditioned on how many time (in a row) and/or within a configured evaluation window the link (e.g., beam) failure events occur such that a measured quality is below the second threshold.

An association of the one or more associations of DL and UL may comprise a linkage between a DL reference (e.g., SSB, CSI-RS, TCI-state) applicable for DL-TRP1 and at least one UL reference (e.g., SSB, SRS, UL-TCI-state) applicable for UL-TRP2. Based on the association, the WTRU may determine a candidate UL beam to be used for a UL transmission (e.g., toward the UL-TRP2), based on selecting (e.g., determining) a DL beam to be recovered to be used for DL receptions.

The WTRU may determine (or explicitly receive an indication of) a first UL-TCI-state (of the plurality of UL-TCI-states) applicable for UL transmissions (e.g., toward the UL-TRP2). The WTRU may determine a first UL spatial-domain filter (e.g., first UL beam) using the first UL TCI-state.

In an example embodiment, the WTRU may perform a first-step BFD (e.g., based on the first max-counter parameter C) and a corresponding first-step BFRR based on using the associated first UL channel type (e.g., PUSCH, PUCCH, MAC-CE). In an example, the WTRU may perform counting the BFD counter (e.g., starting from zero), e.g., increasing by 1, each time a first quality metric (e.g., RSRP, Layer1 (L1)-RSRP, L1-SINR, etc.) measured on a first DL RS of the set of BFD RSs (q_0) is below the first threshold (e.g., Qout, LR).

The WTRU may determine that a beam failure is detected (e.g., the first BFD criteria is satisfied, when measurements of one or more (e.g., all) the BFD RSs are below the first threshold C times) and select a first DL RS (from the set of candidate RSs) that exceeds the second threshold. In an example, the WTRU may determine the BFD counter reaches the first max-counter parameter (C), and determines a second DL RS (q_new) of the set of candidate RSs (q_1) such that a second quality metric of the second DL RS is larger than or equal to the second threshold (e.g., Qin, LR).

Based on the determination (e.g., such that the first BFD criteria is satisfied), the WTRU may transmit (e.g., repeatedly transmits more than one time, re-transmit if allowed by a configuration by NW), using the first UL spatial-domain filter, a first-step BFRR at least comprising an ID of the selected first DL RS, via an available transmission occasion associated with the associated first UL channel type. In an example, the WTRU may (be configured to) transmit the first-step BFRR based on delivering information (e.g., a few bit(s)) to the network that the BFD criteria is met (e.g., without sending the ID of the selected first DL RS). This may provide benefits in terms of improving robustness and latency in the link quality management, e.g., in case when at least the link quality for UL-TRP2 may be okay (e.g., above a threshold) while only the link quality for DL-TRP1 is failed (e.g., below a threshold) or the beam direction from the DL-TRP1 is being blocked.

In an example, the WTRU may transmit the first-step BFRR via an available PUSCH transmission (e.g., MAC-CE) when there is an available PUSCH transmission occasion carrying the MAC-CE, e.g., within a time window associated with the determination of the BFD counter reached to C. In an example, the WTRU may transmit the first-step BFRR via a PUCCH transmission (e.g., a few bits to indicate the selected DL RS ID).

The WTRU may monitor for a response (e.g., a DCI or PDCCH) from the network (e.g., using a first spatial-domain filter determined by the selected first DL RS (q_new)). In an example, the WTRU may perform monitoring (e.g., receiving) the response from the NW via a specific CORESET for the monitoring (e.g., BFR-CORESET), after the transmission of the first-step BFRR.

The WTRU may determine a successful reception of the NW response on condition that at least one of the following criteria is met: a DCI (PDCCH) of the NW response may be received, e.g., within a (configured) first time window for monitoring; the NW response (e.g., DCI, PDCCH) may indicate updating (e.g., replacing) the TCI-state (e.g., that corresponds to the DL RS) with a second TCI-state (of the plurality of TCI-states) to be used for DL receptions (e.g., from the DL-TRP1), and/or the second TCI-state may be associated with the selected first DL RS (q_new); or the NW response may indicate adding the selected first DL RS (q_new) into the set of BFD RSs (q_0), and/or the WTRU may determine one or more measured quality metrics of the selected first DL RS (q_new) are not below the first threshold (Qout, LR). This may provide benefits in terms of improving robustness in that the quality of the recovered first DL RS is confirmed to be above the first threshold after the recovery process (e.g., based on the first-step BFRR). If not confirmed, the WTRU may (be configured to) start over the first-step event-evaluation (e.g., performing the corresponding first-step BFD) and reporting procedure or start performing a second-step event-evaluation (e.g., based on second-step BFD and/or second-step BFRR).

Based on the determination of the successful reception of the NW response, the WTRU may perform at least one of following: the WTRU may (be configured to) reset at least one counter parameter (e.g., C and/or D) of the first and second set of EEPs; or the WTRU may start using (e.g., applying) the recovered DL beam (e.g., the selected first DL RS) on a time occasion determined based on the reception time of the NW response and/or a time offset parameter (which may be (pre-)configured).

In an example, if the time offset parameter is not configured or is configured with a value of zero, the WTRU may start using the recovered DL beam for DL receptions (e.g., from the DL-TRP1) at the reception time of the NW response. In another example, if the time offset parameter is configured with a non-zero value, the WTRU may start using the recovered DL beam for DL receptions (e.g., from the DL-TRP1) at the non-zero value (time) after the reception time of the NW response.

Based on the determination of the successful reception of the NW response, the WTRU may also perform, based on starting using the recovered DL beam for DL receptions (e.g., from the DL-TRP1), the WTRU may (be configured to) update the set of BFD RSs by including the selected first DL-RS (into the set). The WTRU may start over the BFD procedure based on the updated set of BFD RSs (including the first DL-RS).

In an example embodiment, on condition that a response from the network is not received during the time window for monitoring, the WTRU may determine that the second BFD criteria is satisfied (e.g., when the BFD counter reaches D, a time window of D time units is exceeded, or a number of first-step BFRR transmission exceeds a count of D, etc.). In an example, the WTRU may count the BFD counter (e.g., continued from the first max-counter parameter (C)), e.g., increasing by 1, each time the first quality metric measured on the first DL RS of the set of BFD RSs (q_0) is below the first threshold (Qout, LR). The WTRU may determine the BFD counter reaches the second max-counter parameter (D).

Based on the determination, the WTRU may select a second DL RS (from the set of candidate RSs), e.g., that exceeds the second threshold. In an example, the WTRU may determine the second DL RS of the set of candidate RSs (q_1) such that a second quality metric of the second DL RS is larger than or equal to the second threshold (Qin, LR). The determined (e.g., selected) second DL RS may be the same or different from the selected first DL RS.

The WTRU may determine a RACH occasion (RO) that is associated with the second DL RS (q_new), and determine a second UL spatial-domain filter based on a third RS (e.g., targeted toward UL-TRP2) being pre-associated with the second DL RS. In an example, the WTRU may select a RO based on a DL beam (e.g., the second DL RS) but send to the network the information (e.g., ID) of the selected DL beam (e.g., the second DL RS) by using an associated UL beam (e.g., determined based on the second UL spatial-domain filter based on the third RS targeted toward UL-TRP2).

Based on the determinations, the WTRU may transmit, using the second UL spatial-domain filter, a PRACH over the RO, which may represent the second-step BFRR and may be (implicitly) associated with the determined (e.g., selected) second DL RS.

The WTRU may monitor for a response (e.g., a DCI or PDCCH or any pre-configured format of a DL signal) from the network (e.g., using a second spatial-domain filter determined by the selected second DL RS). In an example, the WTRU may perform monitoring (e.g., receiving) the response from the NW via a specific second CORESET for the monitoring (e.g., BFR-CORESET), after the transmission of the second-step BFRR. The second CORESET may be the same or different from the specific CORESET for the first-step BFRR.

The WTRU may determine a successful reception of the NW response on condition that at least one of the following criteria is met: the pre-configured format of the DL signal (e.g., a DCI, PDCCH) of the NW response may be received, e.g., within a (configured) second time window for monitoring. The second time window may be the same or different from the first time window; the NW response (e.g., DCI, PDCCH) may indicate updating (e.g., replacing) the TCI-state (e.g., that corresponds to the DL RS) with a third TCI-state (of the plurality of TCI-states) to be used for DL receptions (e.g., from the DL-TRP1), and/or the third TCI-state may be associated with the selected second DL RS (q_new); or the NW response may indicate adding the selected second DL RS (q_new) into the set of BFD RSs (q_0), and/or the WTRU may determine one or more measured quality metrics of the selected second DL RS are not below the first threshold (Qout, LR). This may provide benefits in terms of improving robustness in that the quality of the recovered second DL RS is confirmed to be above the first threshold after the recovery process. If not confirmed, the WTRU may (be configured to) start over the second-step (or first-step) event-evaluation (e.g., performing the corresponding BFD) and reporting procedure.

Based on the determination of the successful reception of the NW response, the WTRU may perform at least one of following: the WTRU may (be configured to) reset at least one counter parameter (e.g., C and/or D) of the first and second set of EEPs; or the WTRU may start using (e.g., applying) the recovered DL beam (e.g., the selected second DL RS) on a time occasion determined based on the reception time of the NW response and/or a time offset parameter (which may be (pre-)configured).

In an example, if the time offset parameter is not configured or is configured with a value of zero, the WTRU may start using the recovered DL beam for DL receptions (e.g., from the DL-TRP1) at the reception time of the NW response. In another example, if the time offset parameter is configured with a non-zero value, the WTRU may start using the recovered DL beam for DL receptions (e.g., from the DL-TRP1) at the non-zero value (time) after the reception time of the NW response.

Based on the determination of the successful reception of the NW response, the WTRU may perform, based on starting using the recovered DL beam for DL receptions (e.g., from the DL-TRP1), the WTRU may (be configured to) update the set of BFD RSs by including the selected second DL-RS (into the set). The WTRU may start over the BFD procedure based on the updated set of BFD RSs (including the second DL-RS).

In an example embodiment, a WTRU may (be configured to) perform a UL-BFD and/or UL-BFR procedure (to recover a UL beam when a UL-BFD criteria is satisfied), e.g., independently from or in parallel with a DL-BFD/BFR procedure (to recover a DL beam when a DL-BFD criteria is satisfied).

The WTRU may receive an indication of a UL-TCI-state, of the plurality of UL-TCI-states (e.g., associated with the UL-TRP2). In an example, the indication may be based on an indicated UTCI (based on examples of FIG. 5 and/or FIG. 6), for example, when the WTRU is configured with the first mode for UTCI (e.g., Separate DL/UL TCI mode such as the parameter of ‘unifiedTCI-StateType’ set to ‘separate’).

The WTRU may be configured with (e.g., receive configuration for) a set of UL-BFD RSs (e.g., a set q_0_UL), where the WTRU may determine whether a UL-BFD criteria based on one or more RSs in the set of UL-BFD RSs is satisfied or not (e.g., based on using a configured threshold for UL-BFD, based on a configured time window, timer, rule, and so on). In an example, a first RS and a second RS may be comprised in the set of UL-BFD RSs. The WTRU may determine a first quality (e.g., RSRP, L1-RSRP, L1-SINR, etc.) of the first RS is above the threshold and a second quality of the second RS is below the threshold. Based on determining that quality/qualities of at least one RS (e.g., the second RS) of the set of UL-BFD RSs is below the threshold, the WTRU may determine that the UL-BFD criteria is satisfied, and determine to transmit a message (e.g., UL-BFRR) to the network (e.g., informing that the current UL beam quality is low, below the threshold).

In an example embodiment, in response to receiving the indication of the UL-TCI-state (e.g., which may be interpreted as the UL-TCI-state update in terms of a UL beam management procedure), the WTRU may (be configured to) update the set of UL-BFD RSs based on the indication of the UL-TCI-state. In an example, the WTRU may determine that the indicated UL-TCI-state comprises a third RS (e.g., as a QCL-source or QCL-reference of the indicated UL-TCI-state, e.g., for determining a UL beam based on the UL-TCI-state).

Based on the determination, the WTRU may perform updating the set of UL-BFD RSs by including the third RS, where the set of UL-BFD RSs may be updated as {the first RS, the second RS, the third RS}. The WTRU may (e.g., continue to) perform the UL-BFD process based on the updated set of UL-BFD RSs such as {the first RS, the second RS, the third RS}.

In an example, based on the determination, the WTRU may perform updating the set of UL-BFD RSs by replacing a current RS(s) of the current indicated UL-TCI state with the third RS, where the set of UL-BFD RSs may be updated as {the first RS, the third RS}, e.g., on condition that the current RS of the current indicated UL-TCI-state is the second RS. This provide benefits in terms of UL complexity reduction where the number of UL-BFD-RSs may stay unchanged by replacing a current RS (e.g., the second RS) of the current indicated UL-TCI-state with a new RS (e.g., the third RS) of the newly received indicated UL-TCI-state. The WTRU may (e.g., continue to) perform the UL-BFD process based on the updated set of UL-BFD RSs such as {the first RS, the third RS}.

The WTRU may be configured with (e.g., receive configuration for) a set of candidate RSs (e.g., a set q_1_UL) for UL-BFR, e.g., separately (independently) from the set of candidate RSs (set q_1 for DL-BFR). On condition that the WTRU determines the UL-BFD criteria is satisfied, the WTRU may (be configured to) determine a new RS of the set of candidate RSs for UL-BFR, e.g., based on determining that a quality of the new RS is above a configured (UL-new-beam) threshold.

The WTRU may transmit (e.g., report) information based on the new RS (determined as the part of UL-BFR) and/or its quality, etc., via one of following UL transmission methods.

In one example embodiment, the WTRU may transmit (e.g., request to the network) a request signal for the network to turn-ON a TRP's (e.g., the DL-TRP1's) UL reception function, e.g., due to the current UL-TRP2 quality is broken (e.g., based on the determination that the UL-BFD criteria is met).

In one example, the WTRU may transmit the request signal (e.g., toward the DL-TRP1) via a pre-configured special channel such as a type of short PUCCH resource, a type of PRACH, over a particularly configured time/frequency resource, e.g., being granted or pre-configured as a periodic resource with a configured periodicity and time-offset parameters, etc.

In another example, the DL-TRP1 may (currently) be in a NW-energy-saving (NES) mode where the DL-TRP1 is being used for DL transmissions (and not for UL receptions). However, based on receiving the WTRU's transmitted request signal, the NW may turn-ON the DL-TRP1's UL reception functionality (e.g., temporarily) to perform the UL-BFR procedure.

In another example, the WTRU may transmit (e.g., report) the information (for the UL-BFR) by using a spatial-domain filter determined based on a current DL-TCI-state, where the spatial-domain filter may be currently being used for DL receptions from the DL-TRP1. This may imply the WTRU may use the same (or associated) DL beam direction for the UL transmission toward the DL-TRP1 (e.g., based on a beam reciprocity or beam correspondence property, based on the DL-TRP1's UL reception functionality being temporarily turned-ON).

In another example, the WTRU may monitor a NW response, via a (pre-)configured UL-BFR-CORESET, by using the spatial-domain filter, where the UL-BFR-CORESET may be separated from a DL-BFR-CORESET, or shared with the DL-BFR-CORESET, e.g., with one or more flag parameters (such as a separated RNTI used for decoding a DCI of the NW response, an explicit indicator, or an implicit indication based on a pre-configured rule, etc.) for identifying the NW response is for the UL-BFR procedure.

In another example embodiment, the WTRU may be configured with (e.g., receive a configuration for) information on time occasions of DL-TRP1's possible UL reception occasions, e.g., based on a (long) periodicity and/or time offset(s). The possible UL reception occasions (e.g., for DL-TRP1) may be (pre-)configured for such UL-BFR process which may not occur so frequently.

The WTRU may transmit (e.g., report) the information (for the UL-BFR) on a time occasion (e.g., a first available occasion), of the possible UL reception occasions, by using a spatial-domain filter determined based on a current DL-TCI-state, where the spatial-domain filter may be currently being used for DL receptions from the DL-TRP1. This may imply the WTRU may use the same (or associated) DL beam direction for the UL transmission toward the DL-TRP1 (e.g., based on a beam reciprocity or beam correspondence property, based on the DL-TRP1's UL reception functionality turned-on in the possible UL reception occasions).

The WTRU may monitor a NW response, via a (pre-)configured UL-BFR-CORESET, by using the spatial-domain filter, where the UL-BFR-CORESET may be separated from a DL-BFR-CORESET, or shared with the DL-BFR-CORESET, e.g., with one or more flag parameters (such as a separated RNTI used for decoding a DCI of the NW response, an explicit indicator, or an implicit indication based on a pre-configured rule, etc.) for identifying the NW response is for the UL-BFR procedure.

In another embodiment, the WTRU may be configured with (e.g., receive a configuration for) information on time occasions of UL-TRP2's possible DL transmission occasions, e.g., based on a (long) periodicity and/or time offset(s). The possible DL transmission occasions (e.g., for UL-TRP2) may be (pre-)configured for such UL-BFR process which may not occur so frequently.

The WTRU may determine a first DL-spatial-domain-filter based on measuring a first SSB transmitted on a time occasion (e.g., a first available occasion), of the possible DL transmission occasions (e.g., for the UL-TRP2). The WTRU may transmit (e.g., report) the information (for the UL-BFR) on a first RO associated with the first SSB (e.g., based on a separately configured SSB-to-RO-mapping information or rule dedicated for the UL-TRP2), by using the first DL-spatial-domain filter associated with the first SSB (e.g., transmitted from the UL-TRP2).

The WTRU may monitor a NW response, via a (pre-)configured UL-BFR-CORESET, by using the DL-spatial-domain filter if being configured such that the NW response is directly transmitted from the UL-TRP2 (or the spatial-domain filter if being configured such that the NW response is transmitted from the DL-TRP1), where the UL-BFR-CORESET may be separated from a DL-BFR-CORESET, or shared with the DL-BFR-CORESET, e.g., with one or more flag parameters (such as a separated RNTI used for decoding a DCI of the NW response, an explicit indicator, or an implicit indication based on a pre-configured rule, etc.) for identifying the NW response is for the UL-BFR procedure.

In an example embodiment, a WTRU may (be configured to) perform a frequency-resource-specific (e.g., SB-specific) BFR procedure, e.g., where the WTRU may (be configured to) report that one DL SB (out of multiple DL SBs) needs beam failure recovery based on determining that corresponding BFD criteria is met. In an example, the WTRU may be configured with (e.g., receive a configuration for) such SB-specific BFD and/or BFR procedures, based on different CLI conditions across multiple (e.g., non-adjacent) DL SBs, where the WTRU may (be configured to) perform separate CLI measurements and reporting for each group (e.g., configured group) of DL SBs of the multiple DL SBs.

In one example, a first BFR-CORESET may be configured in a first DL SB, e.g., where a DL-TRP1A may transmit DL signals or channels using the first DL SB. For example, the first DL SB may be served by the DL-TRP1A. A second BFR-CORESET may be configured in a second DL SB, e.g., where a DL-TRP1B may transmit DL signals or channels using the second DL SB. For example, the second DL SB may be served by the DL-TRP1B. This may imply two different TRPs are serving the DL transmissions, separately over each DL SB, e.g., over the first DL SB by DL-TRP1A and over the second DL SB by DL-TRP1B.

On condition that the BFD criteria is met on the first DL SB, the WTRU may (be configured to) transmit information on a first failed SB ID (or SB-flag information) corresponding to the first DL SB, via an UL SB (e.g., associated with a UL-TRP2) based on at least one of duplex (e.g., SBFD) SB-related configurations. The WTRU may (be configured to) monitor a NW-response via the first BFR-CORESET (e.g., configured in the first DL SB).

On condition that the BFD criteria is met on the second DL SB, the WTRU may (be configured to) transmit information on a second failed SB ID (or SB-flag information) corresponding to the second DL SB, via an UL SB (e.g., associated with a UL-TRP2) based on at least one of duplex (e.g., SBFD) SB-related configurations. The WTRU may (be configured to) monitor a NW-response via the second BFR-CORESET (e.g., configured in the second DL SB).

In another example, a first BFR-CORESET may be configured in a first DL carrier and/or BWP, e.g., where a DL-TRP1A may transmit DL signals or channels using the first DL carrier and/or BWP. For example, the first DL carrier and/or BWP may be served by the DL-TRP1A. A second BFR-CORESET may be configured in a second DL carrier and/or BWP, e.g., where a DL-TRP1B may transmit DL signals or channels using the second DL carrier and/or BWP. For example, the second DL carrier and/or BWP may be served by the DL-TRP1B. This may imply two different TRPs are serving the DL transmissions, separately over each DL carrier and/or BWP, e.g., over the first DL carrier and/or BWP by DL-TRP1A and over the second DL carrier and/or BWP by DL-TRP1B.

On condition that the BFD criteria is met on the first DL carrier and/or BWP, the WTRU may (be configured to) transmit information on a first failed carrier and/or BWP ID (or a flag information) corresponding to the first DL carrier and/or BWP, via an UL SB or a UL carrier and/or BWP (e.g., associated with a UL-TRP2), based on at least one of duplex (e.g., SBFD) SB-related configurations, carrier aggregation (CA) related configurations, and/or dual connectivity (DC) related configurations. The WTRU may (be configured to) monitor a NW-response via the first BFR-CORESET (e.g., configured in the first DL carrier and/or BWP).

On condition that the BFD criteria is met on the second DL carrier and/or BWP, the WTRU may (be configured to) transmit information on a second failed carrier and/or BWP ID (or a flag information) corresponding to the second DL carrier and/or BWP, via an UL SB or a UL carrier and/or BWP (e.g., associated with a UL-TRP2), based on at least one of duplex (e.g., SBFD) SB-related configurations, carrier aggregation (CA) related configurations, and/or dual connectivity (DC) related configurations. The WTRU may (be configured to) monitor a NW-response via the second BFR-CORESET (e.g., configured in the second DL carrier and/or BWP).

In an example embodiment, a WTRU may be configured to perform Carrier Aggregation (CA) (or dual connectivity (DC)) with multiple cells for achieving high data rate. For example, the WTRU may perform CA with multiple cells (e.g., SCells in MCG/SCG) wherein a cell (e.g., one cell, a group of cells) may support SBFD symbols and/or another cell (e.g., another group of cells) may not support SBFD symbols. For example, the WTRU may receive a condition(s) for CA (or DC) (e.g., performing aggregating at least one SCell in MCG/SCG and/or PSCell) from a network. The condition may be configured via MAC CE/RRC message to the WTRU. For example, the condition may be activated via L1 signaling (e.g., DCI, PDCCH order). For example, the condition may indicate CLI level associated with DL subbands/subset/DL BWP of the cell/TRP.

Upon receiving the CA (or DC) configuration, where at least one cell (e.g., SCell) with supporting SBFD symbols may be configured for CA (or DC), the WTRU may perform CLI measurement on each of the carrier/cell/TRP with supporting SBFD symbols.

For example, when measured CLI level with at least one DL subbands/subset/DL BWL of the cell/TRP is below the configured threshold (e.g., CLI level) and/or no CLI detection, then WTRU may report measurement results of the cell (e.g., candidate configurable SCell for CA (or DC)) to the network. For example, the WTRU may apply (e.g., set) different CLI thresholds for different each of the carriers/cells/TRPs (e.g., PSCell, SCell, DL-only cell, UL-only cell).

For example, when a WTRU performs CA (or DC) with configured multiple cells if the measured CLI level with at least one DL subbands/subset/DL BWP of the cell/TRP is above the configured threshold, then WTRU may report measurement results or a request associated cell/TRP (e.g., for switching, reconfiguring, and/or releasing the associated SCell, e.g., to be removed/deactivated, for CA (or DC)) to the network. For example, the WTRU may report measurement results or request according to periodic-event and/or event-based aperiodically.

In one example, a WTRU may be configured with CA (or DC) with multiple carriers. For example, a first BFR-CORESET is associated with a first group of carriers/cells and/or a second BFR-CORESET is associated with a second group of carriers/cells. For example, if at least one cell (e.g., SCell) with supporting SBFD symbols is configured for CA (or DC), the WTRU may perform CLI measurement on each of the carrier/cell/TRP with supporting SBFD symbols.

Upon receiving (e.g., receiving configuration for) a BFR-CORESET associated with cells/TRPs which support SBFD symbols, the WTRU may determine to perform BFR, e.g., if a BFD criteria is satisfied, based on the measured CLI level of a carrier/cell/TRP of the cells/TRPs. For example, if measured CLI level associated with the BFR-CORESET with a cell/TRP of the cells/TRPs (e.g., based on measurements on SSB/CSI-RS) is below a configured threshold and/or with no CLI detection, the WTRU may determine to perform BFR on the cell/TRP which support SBFD symbols (e.g., using SBFD symbols). The WTRU may send a BFR request (BFRR) to the network, and may monitor a NW response via the first BFR-CORESET.

For example, if there are no available cells/TRPs (e.g., all measured CLI levels of the cells/TRPs are above the threshold), the WTRU may determine to perform the BFR, if a BFD criteria is satisfied, with a carrier/cell/TRP, of the second group of carriers/cells, which does not support SBFD symbols (e.g., not using SBFD symbols). The WTRU may send a BFR request (BFRR) to the network if measured CLI level associated BFR-CORESET with cell/TRP (e.g., SSB/CSI-RS) is above the configured threshold. For example, the WTRU may send the BFRR according to the periodic-event and/or event-based via MAC CE and/or RRC message. The WTRU may monitor a NW response via the second BFR-CORESET.

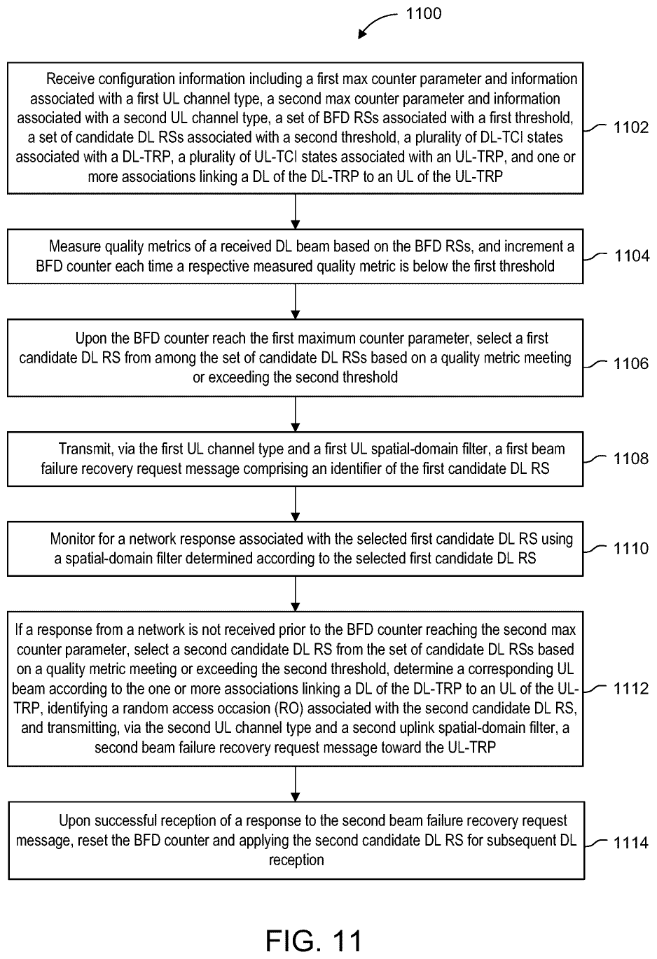

FIG. 11 is a flow diagram of an example BFR hybrid beam failure recovery (BFR) process based on multi-step BFR operations.

In some implementations, one or more process blocks of FIG. 11 may be performed by a WTRU.

As shown in FIG. 11, process 1100 may include, at 1102, receiving configuration information that includes a first maximum counter parameter and information associated with a first uplink (UL) channel type, a second maximum counter parameter and information associated with a second UL channel type, a set of beam failure detection (BFD) reference signals (RSs) associated with a first threshold, and a set of candidate downlink (DL) RSs associated with a second threshold. For example, a WTRU may receive configuration information that includes a first maximum counter parameter and information associated with a first UL channel type, a second maximum counter parameter and information associated with a second UL channel type, a set of beam failure detection BFD RS associated with a first threshold, and a set of candidate DL RSs associated with a second threshold, as described above. As also shown in FIG. 11, process 1100 may include, at 1104, measuring quality metrics of a received DL beam based on the BFD RSs, and incrementing a BFD counter each time a respective measured quality metric is below the first threshold. For example, The WTRU may measure quality metrics of a received DL beam based on the BFD RS, and increment a BFD counter each time a respective measured quality metric is below the first threshold, as described above. As further shown in FIG. 11, process 1100 may include, at 1106, performing a first beam failure recovery (BFR) operation when the BFD counter reaches the first maximum counter parameter, where the first BFR operation includes selecting a first candidate DL RS. For example, WTRU may perform a first beam failure recovery (BFR) operation when the BFD counter reaches the first maximum counter parameter, where the first BFR operation includes selecting a first candidate DL RS, as described above. As also shown in FIG. 11, process 1100 may include, at 1108, monitoring for a network response associated with the first BFR operation. For example, WTRU may monitor for a network response associated with the first BFR operation, as described above. As further shown in FIG. 11, process 1100 may include, at 1110, if the network response associated with the first BFR operation is not received prior to the BFD counter reaching the first maximum counter parameter, performing a second BFR operation, where the second BFR operation includes selecting a second candidate DL RS. For example, WTRU may if the network response associated with the first BFR operation is not received prior to the BFD counter reach the first maximum counter parameter, performing a second BFR operation, where the second BFR operation includes selecting a second candidate DL RS, as described above. As also shown in FIG. 11, process 1100 may include, at 1112, resetting the BFD counter and applying the second candidate DL RS for subsequent DL reception upon successful reception of a response to the second BFR operation. For example, WTRU may reset the bfd counter and applying the second candidate DL RS for subsequent DL reception upon successful reception of a response to the second BFR operation, as described above.

Process 1100 may include additional implementations, such as any single implementation or any combination of implementations described below and/or in connection with one or more other processes described elsewhere herein. In a first implementation, the configuration information further includes a plurality of DL transmission configuration indicator (DL-TCI) states associated with a DL transmission point (DL-TRP), a plurality of UL-TCI states associated with an UL transmission point (UL-TRP), and one or more associations linking one or more DL resources or parameters of the DL-TRP to one or more UL resources or parameters of the UL-TRP.

In a second implementation, alone or in combination with the first implementation, the first BFR operation may include: selecting the first candidate DL RS from among the set of candidate DL RSs based on a quality metric of the first candidate DL RS meeting or exceeding the second threshold; and transmitting, using the first UL channel type and a first UL spatial-domain filter, a first beam failure recovery request message having an identifier of the first candidate DL RS, and where the network response being monitored is associated with the selected first candidate DL RS using a spatial-domain filter determined according to the selected first candidate DL RS.

In a third implementation, alone or in combination with the first and second implementation, second BFR operation may include: selecting the second candidate DL RS from the set of candidate DL RSs based on a quality metric of the second candidate DL RS meeting or exceeding the second threshold, determining a corresponding UL beam according to the one or more associations linking one or more DL resources or parameters of the DL-TRP to one or more UL resources or parameters of the UL-TRP, identifying a random access occasion (RO) associated with the second candidate DL RS, and transmitting, using the second UL channel type and a second uplink spatial-domain filter, a second beam failure recovery request message toward the UL-TRP.

In a fourth implementation, alone or in combination with one or more of the first through third implementations, the first UL spatial-domain filter is determined based on one of the UL-TCI states, and where the second uplink spatial-domain filter is determined based on the corresponding UL beam.

A fifth implementation, alone or in combination with one or more of the first through fourth implementations, process 1100 may include determining a first UL-TCI state from the plurality of UL-TCI states associated with the UL-TRP for performing UL transmissions.

In a sixth implementation, alone or in combination with one or more of the first through fifth implementations, the first UL channel type may include one of a physical uplink shared channel (PUSCH), a physical uplink control channel (PUCCH), or a media access control (MAC) control element (MAC-CE), and where the second UL channel type may include a physical random access channel (PRACH).

In a seventh implementation, alone or in combination with one or more of the first through sixth implementations, the one or more associations linking one or more DL resources or parameters of the DL-TRP to one or more UL resources or parameters of the UL-TRP include an association linking of any one of: a DL SSB, CSI-RS, or DL TCI state associated with the DL-TRP with any one of: an UL SSB, SRS, or UL-TCI state associated with the UL-TRP.

In an eighth implementation, alone or in combination with one or more of the first through seventh implementations, identifying the RO associated with the second candidate DL RS is based on a preconfigured SSB-to-RO mapping rule.

In a ninth implementation, alone or in combination with one or more of the first through eighth implementations, measuring quality metrics of the received DL beam may include measuring a reference signal received power (RSRP), and where the first threshold is based on a predetermined RSRP threshold.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for recovering a downlink beam performed by a wireless transmit/receive unit (WTRU), the method comprising:
receiving configuration information that includes a first maximum counter parameter and information associated with a first uplink (UL) channel type, a second maximum counter parameter and information associated with a second UL channel type, a set of beam failure detection (BFD) reference signals (RSs) associated with a first threshold, and a set of candidate downlink (DL) RSs associated with a second threshold;
measuring quality metrics of a received DL beam based on the BFD RSs, and incrementing a BFD counter each time a respective measured quality metric is below the first threshold;
performing a first beam failure recovery (BFR) operation when the BFD counter reaches the first maximum counter parameter, wherein the first BFR operation includes selecting a first candidate DL RS;
monitoring for a network response associated with the first BFR operation;
if the network response associated with the first BFR operation is not received prior to the BFD counter reaching the first maximum counter parameter, performing a second BFR operation, wherein the second BFR operation includes selecting a second candidate DL RS; and
resetting the BFD counter and applying the second candidate DL RS for subsequent DL reception upon successful reception of a response to the second BFR operation.

2. The method of claim 1, wherein the configuration information further includes a plurality of DL transmission configuration indicator (DL-TCI) states associated with a DL transmission point (DL-TRP), a plurality of UL-TCI states associated with an UL transmission point (UL-TRP), and one or more associations linking one or more DL resources or parameters of the DL-TRP to one or more UL resources or parameters of the UL-TRP.

3. The method according to claim 2, wherein the first BFR operation comprises:
selecting the first candidate DL RS from among the set of candidate DL RSs based on a quality metric of the first candidate DL RS meeting or exceeding the second threshold; and
transmitting, using the first UL channel type and a first UL spatial-domain filter, a first beam failure recovery request message comprising an identifier of the first candidate DL RS, and wherein the network response being monitored is associated with the selected first candidate DL RS using a spatial-domain filter determined according to the selected first candidate DL RS.

4. The method of claim 3, wherein the second BFR operation comprises: selecting the second candidate DL RS from the set of candidate DL RSs based on a quality metric of the second candidate DL RS meeting or exceeding the second threshold, determining a corresponding UL beam according to the one or more associations linking one or more DL resources or parameters of the DL-TRP to one or more UL resources or parameters of the UL-TRP, identifying a random access occasion (RO) associated with the second candidate DL RS, and transmitting, using the second UL channel type and a second uplink spatial-domain filter, a second beam failure recovery request message toward the UL-TRP.

5. The method of claim 4, wherein the first UL spatial-domain filter is determined based on one of the UL-TCI states, and wherein the second uplink spatial-domain filter is determined based on the corresponding UL beam.

6. The method of claim 4, further comprising determining a first UL-TCI state from the plurality of UL-TCI states associated with the UL-TRP for performing UL transmissions.

7. The method of claim 4, wherein the first UL channel type comprises one of a physical uplink shared channel (PUSCH), a physical uplink control channel (PUCCH), or a media access control (MAC) control element (MAC-CE), and wherein the second UL channel type comprises a physical random access channel (PRACH).

8. The method of claim 4, wherein the one or more associations linking one or more DL resources or parameters of the DL-TRP to one or more UL resources or parameters of the UL-TRP include an association linking of any one of: a DL SSB, CSI-RS, or DL TCI state associated with the DL-TRP with any one of: an UL SSB, SRS, or UL-TCI state associated with the UL-TRP.

9. The method of claim 4, wherein identifying the RO associated with the second candidate DL RS is based on a preconfigured SSB-to-RO mapping rule.

10. The method of claim 4, wherein measuring quality metrics of the received DL beam comprises measuring a reference signal received power (RSRP), and wherein the first threshold is based on a predetermined RSRP threshold.

11. A wireless transmit/receive unit (WTRU) comprising:
processor circuitry; and
a transceiver coupled to the processor circuitry and configured to receive configuration information that includes a first maximum counter parameter and information associated with a first uplink (UL) channel type, a second maximum counter parameter and information associated with a second UL channel type, a set of beam failure detection (BFD) reference signals (RSs) associated with a first threshold, and a set of candidate downlink (DL) RSs associated with a second threshold;
the processor circuitry configured to:
measure quality metrics of a received DL beam based on the BFD RSs, and incrementing a BFD counter each time a respective measured quality metric is below the first threshold;
perform a first beam failure recovery (BFR) operation when the BFD counter reaches the first maximum counter parameter, wherein the first BFR operation includes selecting a first candidate DL RS;
monitor for a network response associated with the first BFR operation;
if the network response associated with the first BFR operation is not received prior to the BFD counter reaching the first maximum counter parameter, perform a second BFR operation, wherein the second BFR operation includes selecting a second candidate DL RS; and
reset the BFD counter and applying the second candidate DL RS for subsequent DL reception upon successful reception of a response to the second BFR operation.

12. The WTRU of claim 11, wherein the configuration information further includes a plurality of DL transmission configuration indicator (DL-TCI) states associated with a DL transmission point (DL-TRP), a plurality of UL-TCI states associated with an UL transmission point (UL-TRP), and one or more associations linking one or more DL resources or parameters of the DL-TRP to one or more UL resources or parameters of the UL-TRP.

13. The WTRU of claim 12, wherein the processor circuitry is configured to select the first candidate DL RS from among the set of candidate DL RSs based on a quality metric of the first candidate DL RS meeting or exceeding the second threshold; and
the transceiver is configured to transmit, using the first UL channel type and a first UL spatial-domain filter, a first beam failure recovery request message comprising an identifier of the first candidate DL RS, and wherein the network response being monitored is associated with the selected first candidate DL RS using a spatial-domain filter determined according to the selected first candidate DL RS.

14. The WTRU of claim 13, wherein the processor circuitry is configured to select the second candidate DL RS from the set of candidate DL RSs based on a quality metric of the second candidate DL RS meeting or exceeding the second threshold, determine a corresponding UL beam according to the one or more associations linking one or more DL resources or parameters of the DL-TRP to one or more UL resources or parameters of the UL-TRP, and identify a random access occasion (RO) associated with the second candidate DL RS, and the transceiver is configured to transmit, using the second UL channel type and a second uplink spatial-domain filter, a second beam failure recovery request message toward the UL-TRP.

15. The WTRU of claim 14, wherein the first UL spatial-domain filter is determined based on one of the UL-TCI states, and wherein the second uplink spatial-domain filter is determined based on the corresponding UL beam.

16. The WTRU of claim 14, the processor circuitry is further configured to determine a first UL-TCI state from the plurality of UL-TCI states associated with the UL-TRP used to perform UL transmissions.

17. The WTRU of claim 14, the first UL channel type comprises one of a physical uplink shared channel (PUSCH), a physical uplink control channel (PUCCH), or a media access control (MAC) control element (MAC-CE), and wherein the second UL channel type comprises a physical random access channel (PRACH).

18. The WTRU of claim 14, wherein the one or more associations linking one or more DL resources or parameters of the DL-TRP to one or more UL resources or parameters of the UL-TRP include an association linking of any one of: a DL SSB, CSI-RS, or DL TCI state associated with the DL-TRP with any one of: an UL SSB, SRS, or UL-TCI state associated with the UL-TRP.

19. The WTRU of claim 14, wherein the processor circuitry is configured to identify the RO associated with the second candidate DL RS is based on a preconfigured SSB-to-RO mapping rule.

20. The WTRU of claim 19, wherein the processor circuitry is configured to measure the quality metrics of the received DL beam based on reference signal received power (RSRP), and wherein the first threshold is based on a predetermined RSRP threshold.
